(19) United States
(12) Patent Application Publication
(10) Pub. No.: US 2020/0143104 A1
(43) Pub. Date: May 7, 2020

(54) METHODS FOR ARBITRATING ONLINE DISPUTES AND ANTICIPATING OUTCOMES USING MACHINE INTELLIGENCE

(71) Applicant: Zachary Peoples, Santa Monica, CA (US)

(72) Inventor: Zachary Peoples, Santa Monica, CA (US)

(21) Appl. No.: 16/734,265

(22) Filed: Jan. 3, 2020

Related U.S. Application Data
(63) Continuation of application No. 16/505,447, filed on Jul. 8, 2019.
Application No. 16/505,447 is a continuation of application No. 16/249,717, filed on Jan. 16, 2019, now abandoned.
Application No. 16/249,717 is a continuation of application No. 15/671,059, filed on Aug. 7, 2017, now abandoned.

(51) Int. Cl. G06F 40/134; G06F 16/70; G06F 16/432; G06N 7/00; G06N 20/00; G06Q 10/00; G06F 40/226

(52) U.S. Cl. CPC G06F 40/134; G06F 16/70; G06F 16/433; G06N 5/02; G06N 20/00; G06Q 10/00; G06F 40/226; G06N 7/005

(57) ABSTRACT

Methods for conflict arbitration and resolution anticipation through machine intelligence learning are provided herein. Methods for hypothesizing by a machine intelligence such that predictions of user text strings put forth from one demographic may be proposed. Methods for pattern recognition between demographical user groups and similar user solutions are provided herein. Methods for lexical matrix construction by a machine intelligence in which root meanings of user text strings are used to associate groups of similar user text strings. Methods for semantic and polarity analysis as well as natural language processing are also employed. Methods for allowing Internet users to air their grievances and put forth solutions to said grievances in an online and/or mobile setting are provided. Methods for summarizing and categorizing cases of user disputes for hypothesizing and determining patterns between demographical groups and similar solutions are provided herein.

### PRIORITY

This application claims the benefit of co-pending application Ser. No. 16/505,447 filed Jul. 8, 2019 by the same inventor, which in turns claims the benefit of application Ser. No. 16/249,717 filed Jan. 16, 2019, which in turn claims the benefit of application Ser. No. 15/671,059 filed Aug. 7, 2017. All of which are incorporated by reference as if fully set forth herein.

### BACKGROUND

### Field of Invention

Embodiments of the present disclosure relate generally to methods for managing disputes and anticipating outcomes using machine intelligence, and more specifically to using natural language processing, sentiment and polarity analysis to analyze user-submitted text, demographical data and other information, and using the results to generate and evolve hypotheses used to predict user verdicts and solutions, and iterating hypotheses and hypothesis occurrence probabilities thereby refining a machine intelligence.

### Description of Related Art

Methods, devices and software currently exist that allow users to air disputes publicly, such as court reality TV shows, Facebook and courts at law and equity. However, none of these methods provide the benefits of conflict arbitration and resolution anticipation by a machine intelligence and other processing methods.

### SUMMARY

Embodiments disclosed herein also provide for a conflict arbitration and resolution anticipation through machine intelligent learning (which may be referred to as “CARAMIL”).

In some embodiments, a user (complainant user, complainant party, or complainant) may represent themselves in CARAMIL. In one embodiment, the complainant may air their grievances, by way of example and not limitation, describing details of an infraction event allegedly committed by a second user. These details may be referred to as the offense.

In further embodiments, this second user (respondent user, respondent party, or respondent), may also represent themselves and defend against the complainant's offense. In one embodiment, the respondent may describe the details of the infraction event from the respondent's point of view (referred to as the defense). Together, the complainant user and respondent user may be referred to as “the parties,” and the offense and defense may be referred to as “the trial.” After each party has represented themselves, the parties may opt to submit more material to contribute to their offense/defense. In some embodiments, the offense and defense may be saved in cloud storage.

In even further embodiments, during trial other users (juror users, jury or jurors) may review the details of the offense and defense in a period called deliberation. Together, the complainant, respondent and jurors from a particular case may be referred to as trial users. In one embodiment, jurors may contribute information in the form of text opinions (jury conference data). In a further embodiment the jury conference data and trial data may be saved in cloud storage. In a further embodiment, case data may be locked before deliberation begins, allowing for jury users to view case data preserved since the end of the case. In another embodiment, complainant and/or respondent user may be able to comment on user comments and/or verdicts or case outcomes.

In some embodiments, juror users may be preselected based on, by way of example and not limitation, demographics. In further embodiments, deliberation ends after a set period of time, and jurors may vote for either the complainant or respondent, resulting in a win for either the complainant or respondent (verdict data or verdict). Together, the data from by way of example and not limitation, one or more of the following: offense, defense, deliberation and verdict, may be referred to herein as trial data.

Embodiments disclosed herein may also provide for a conflict arbitration and resolution anticipation through machine intelligent generation of hypotheses targeted towards predicting case outcomes. In a further embodiment, hypotheses are iterated based on each case outcome and occurrence probabilities associated with said hypothesis are updated as cases are adjourned. In this manner, the machine intelligence is continuously refined and improved. In one embodiment, the refinement process may rely on, by way of example and not limitation, natural language processing (NLP), sentiment and polarity analysis and learned algorithms used to parse through trial data, sentiment data and predict jury verdicts as well as solutions proposed by one or more of complainant, respondent or jury users. In an additional embodiment, all of this data may be saved and iterated upon causing refinement and improvement and thus allowing for increased accuracy of verdict and solution prediction by the machine intelligence.

Embodiments disclosed herein may also provide for lexical matrix construction in which user text may be parsed and root meanings determined and associated with individual words in the user text. In this manner, definitions may be expanded and new words may be catalogued and associated with additional meaning such as definitions, synonyms, antonyms and social or contextual connotations (understood) by a machine intelligence.

Embodiments disclosed herein also provide for demographical subgrouping in which users may be arranged by demographical analysis.

Embodiments disclosed herein may also provide for correlational processing between demographical groups and lexical matrices in order to predict textual content made by demographical groups. In one embodiment, textual content made my demographical groups that may be predicted by a machine intelligence include user-provided solutions. In this embodiment, correlational processing between demographical groups and lexical matrices allows for a machine intelligence to predict solutions provided by users within a demographical group.

Embodiments disclosed herein provide for sentiment and polarity analysis of text strings inputted by users of embodiment disclosed herein. In some embodiments, such analysis contributes towards a machine intelligence's ability to predict textual context made by demographical groups. While different means for sentiment and polarity analysis are presented herein, this disclosure is intended to include conventional means to effectuate these techniques in some embodiments, including online service providers.

### BRIEF DESCRIPTION OF THE DRAWINGS

FIG. 1 shows a functional block diagram of a client-server system that may be employed for some embodiments according to the current disclosure

FIG. 2 illustrates a mobile application to allow users to interact with the conflict arbitration and resolution anticipation through machine intelligent learning, according to one embodiment of the current disclosure.

FIG. 3 illustrates predictive analytics used in natural language processing for attempting prediction of jury verdicts, according to one embodiment of the current disclosure.

FIG. 4A illustrates processing of trial context data and case data table elements, according to certain embodiments of the current disclosure.

FIG. 4B illustrates processing of trial context data and case data table elements, according to certain embodiments of the current disclosure.

FIG. 4C illustrates processing of trial context data and case data table elements, according to certain embodiments of the current disclosure.

FIG. 4D illustrates processing of trial context data and case data table elements, according to certain embodiments of the current disclosure.

FIG. 5 illustrates data storage locations, according to one embodiment of the current disclosure.

FIG. 6A illustrates, in part, the stages for refinement of a machine intelligence and a lexical matrix, according to one embodiment of the current disclosure.

FIG. 6B illustrates, in part, the stages for refinement of a machine intelligence and a lexical matrix, according to one embodiment of the current disclosure.

FIG. 7A illustrates, in part, a method for case creation, according to one embodiment of the current disclosure.

FIG. 7B illustrates, in part, a method for case creation, according to one embodiment of the current disclosure.

FIG. 7C illustrates, in part, a method for case creation, according to one embodiment of the current disclosure.

FIG. 8 illustrates a method for inviting a respondent to participate in a new case, according to one embodiment of the current disclosure;

FIG. 9 illustrates a method for case selection for jury users, according to one embodiment of the current disclosure.

FIG. 10A illustrates, in part, a method for filtration of user text input strings for trigger words, according to one embodiment of the current disclosure.

FIG. 10B illustrates, in part, a method for filtration of user text input strings for trigger words, according to one embodiment of the current disclosure.

FIG. 11A illustrates, in part, a method for lexical matrix construction, according to one embodiment of the current disclosure.

FIG. 11B illustrates, in part, a method for lexical matrix construction, according to one embodiment of the current disclosure.

FIG. 12A illustrates, in part, a method for sentiment and polarity analysis, according to one embodiment of the current disclosure.

FIG. 12B illustrates, in part, a method for sentiment and polarity analysis, according to one embodiment of the current disclosure.

FIG. 13A, illustrates, in part, a method for conducting voir dire and deliberation, according to one embodiment of the current disclosure.

FIG. 13B, illustrates, in part, a method for conducting voir dire and deliberation, according to one embodiment of the current disclosure.

FIG. 13C, illustrates, in part, a method for conducting voir dire and deliberation, according to one embodiment of the current disclosure.

FIG. 14 illustrates a method for generating verdicts, according to one embodiment of the current disclosure.

FIG. 15A illustrates, in part, a method for a synonym array generation performed by a machine intelligence, according to one embodiment of the current disclosure.

FIG. 15B illustrates, in part, a method for a synonym array generation performed by a machine intelligence, according to one embodiment of the current disclosure.

FIG. 16 illustrates method for case issue comparison and case issue sorting by a machine intelligence, according to one embodiment of the current disclosure.

FIG. 17A illustrates, in part, a method for hypothesizing and pattern recognition between user demographics and previous case solutions by a machine intelligence, according to one embodiment of the current disclosure.

FIG. 17B illustrates, in part, a method for hypothesizing and pattern recognition between user demographics and previous case solutions by a machine intelligence, according to one embodiment of the current disclosure.

FIG. 18 illustrates a method for a hypothesis occurrence iteration and refinement that may executed by a machine intelligence, according to one embodiment of the current disclosure.

### DETAILED DESCRIPTION

### Generality of Invention

This application should be read in the most general possible form. This includes, without limitation, the following:

References to specific techniques include alternative and more general techniques, especially when discussing aspects disclosed herein, or how the embodiment might be made or used.

References to “preferred” techniques generally mean that the inventor contemplates using those techniques, and thinks they are best for the intended application. This does not exclude other techniques for the invention, and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit disclosed herein, and these variations would become clear to those skilled in the art after perusal of this application.

### Lexicon

CARAMIL: as used herein CARAMIL may refer to a method of conflict arbitration and resolution anticipation through machine learning, a system that performs that method, or, in some contexts, parts of a method or system to effectuate that method.

User sentiment: generally refers to the mean sentiment score result from sentiment analysis over multiple strings of text inputted by a user.

Synonyms: generally refers to words or phrases similar to other similar words or phrases based on meaning or other criteria.

Etymological analysis or iterative etymological analysis: generally refers to processing of words for synonyms, deeper root meanings, and/or emotional or contextual connotations. Iterative refers to the possibility that etymological analysis in this manner may occur repeatedly until a final root or core meaning is found.

Lexical matrix: generally refers to a type of “sentence” formed wherein one array may contain cells with “root” word or words that represent a user suggestions, and each cell may be related to another array of neighboring synonyms. The distance from the root word(s) may reflect the degree of relationship with neighboring synonyms and the root word(s), similar to that used in a k-nearest neighbors (kNN) algorithm.

Hypothesis: generally refers to distillation of multiple user suggestions into lexical matrices.

Deliberation: generally refers to a period of time (e.g. 24 hrs) where the community can vote on a case.

Case data or case metadata: generally refers to information submitted by CARAMIL users related to a case or other users, or information gleaned by CARAMIL from other case data.

Metadata: generally refers to data about other data, by way of example and not limitation, data about words use in a case.

Case: generally refers to a disagreement between a complainant user and a respondent user illustrated by a conversation via an online chat room.

Comment: generally refers to a text-based remark from a user about a case.

Origin word: generally refers to a word original to user comment.

Nexus cell: generally refers to a cell in a lexical matrix associated with, by way of example and not limitation, one or more of the following: synonym arrays, user text string arrays, degree match or similarity/proximity arrays and other arrays mentioned herein.

Complainant: generally refers to CARAMIL user who initiates a case.

Respondent: generally refers to CARAMIL user who responds to an invitation by a complainant user

Jury user: generally refers to CARAMIL users who share advice and/or experiences to help complainant and respondent find resolution.

Jury selection criteria: generally refers to a complainant and/or respondent users to select filters (age, gender, city, etc.) determining who has access to view/vote on their case.

### Processing System

The methods and techniques described herein may be performed on a processor-based device. The processor-based device will generally comprise a processor attached to one or more memory devices or other tools for persisting data. These memory devices will be operable to provide machine-readable instructions to the processors and to store data. Certain embodiments may include data acquired from remote servers. The processor may also be coupled to various input/output (I/O) devices for receiving input from a user or another system and for providing an output to a user or another system. These I/O devices may include human interaction devices such as keyboards, touch screens, displays and terminals as well as remote connected computer systems, modems, radio transmitters and handheld personal communication devices such as cellular phones, “smart phones”, digital assistants and the like.

The processing system may also include mass storage devices such as disk drives and flash memory modules as well as connections through I/O devices to servers or remote processors containing additional storage devices and peripherals.

Certain embodiments may employ multiple servers and data storage devices thus allowing for operation in a cloud or for operations drawing from multiple data sources. The inventors contemplate that the methods disclosed herein will also operate over a network such as the Internet, and may be effectuated using combinations of several processing devices, memories and I/O. Moreover any device or system that operates to effectuate techniques according to the current disclosure may be considered a server for the purposes of this disclosure if the device or system operates to communicate all or a portion of the operations to another device.

The processing system may be a wireless device such as a smart phone, personal digital assistant (PDA), laptop, notebook and tablet computing devices operating through wireless networks. These wireless devices may include a processor, memory coupled to the processor, displays, keypads, WiFi, Bluetooth, GPS and other I/O functionality. Alternatively the entire processing system may be self-contained on a single device.

In general, the routines executed to implement the current disclosure, may be implemented as part of an operating system or a specific application, component, program, object, module or sequence of instructions referred to as “computer programs,” apps, widgets, and the like. The computer programs typically comprise one or more instructions set at various times in various memory and storage devices in a computer, and that, when read and executed by one or more processors in a computer, cause the computer to perform operations necessary to execute elements involving the various aspects disclosed herein. Moreover, while the invention has been described in the context of fully functioning computers and computer systems, those skilled in the art will appreciate that the various embodiments are capable of being distributed as a program product in a variety of forms, and that the current disclosure applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

### Client Server Processing

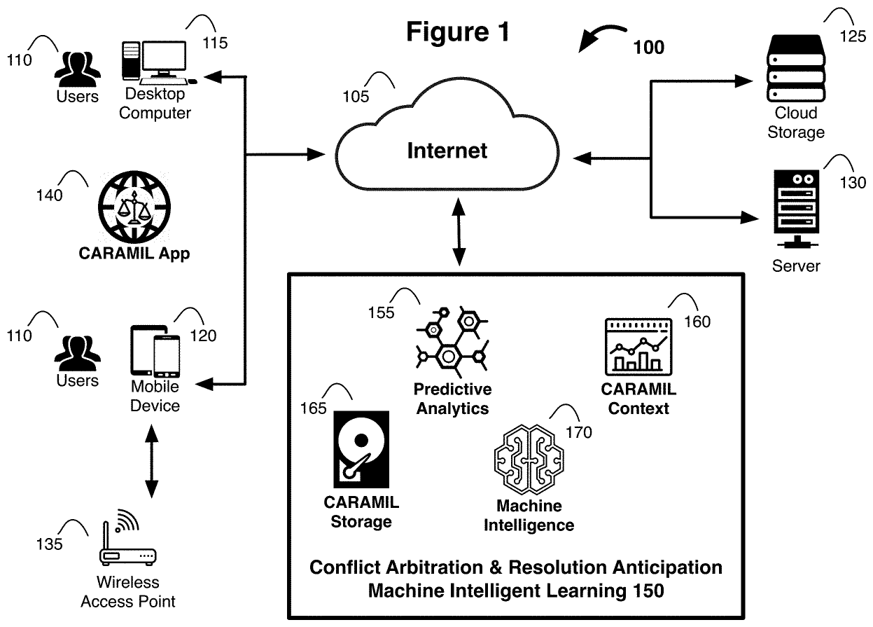

FIG. 1 shows a functional block diagram of a client-server system 100 that may be employed for some embodiments according to the current disclosure. In the FIG. 1, one or more servers such as server 130 may be coupled to a database such as cloud storage 125 and to a network such as Internet 105. The network may include routers, hubs and other equipment to effectuate communications between all associated devices. A user 110 accesses the server by a computer 115 communicably coupled to the Internet 105. The computer 115 includes a sound capture device such as a microphone (not shown). Alternatively the user may access the server 130 through the Internet 105 by using mobile device 120. Mobile device 120 may include smartphones, PDAs, tablet PCs. Mobile device 120 may connect to the server 130 through an access point 135 coupled to the Internet 105. Mobile device 120 includes a sound capture device such as a microphone. Mobile device 120 and desktop computer 115 support CARAMIL App 140.

CARAMIL App may either be a website link or an mobile app stored on mobile device 120 and desktop computer 115. CARAMIL App 140 communicates data through Internet 105 to Conflict Anticipation & Management System (CARAMIL) 150. CARAMIL 150 includes Predictive Analytics 155, which may encapsulate scripts that collect, organize, analyze and report predictive insights about cases. CARAMIL 150 may organize data into predetermined data tables in CARAMIL Context 160 and store case data in CARAMIL Storage 165.

Conventionally, client server processing operates by dividing the processing between two devices such as a server and a smart device such as a cell phone or other computing device. The workload is divided between the servers and the clients according to a predetermined specification. For example in a “light client” application, the server does most of the data processing and the client does a minimal amount of processing, often merely displaying the result of processing performed on a server.

According to the current disclosure, client-server applications are structured so that the server provides machine-readable instructions to the client device and the client device executes those instructions. The interaction between the server and client indicates which instructions are transmitted and executed. In addition, the client may, at times, provide for machine readable instructions to the server, which in turn executes them. Several forms of machine readable instructions are conventionally known including applets and are written in a variety of languages including Java, JavaScript, Python and JSON.

Client-server applications also provide for software as a service (SaaS) applications where the server provides software to the client on an as needed basis.

In addition to the transmission of instructions, client-server applications also include transmission of data between the client and server. Often this entails data stored on the client to be transmitted to the server for processing. The resulting data is then transmitted back to the client for display or further processing.

One having skill in the art will recognize that client devices may be communicably coupled to a variety of other devices and systems such that the client receives data directly and operates on that data before transmitting it to other devices or servers. Thus data to the client device may come from input data from a user, from a memory on the device, from an external memory device coupled to the device, from a radio receiver coupled to the device or from a transducer coupled to the device. The radio may be part of a wireless communications system such as a “WiFi” or Bluetooth receiver. Transducers may be any of a number of devices or instruments such as thermometers, pedometers, health measuring devices and the like.

A client-server system may rely on “engines” which include processor-readable instructions (or code) to effectuate different elements of a design. Each engine may be responsible for differing operations and may reside in whole or in part on a client, server or other device. As disclosed herein a display engine, a data engine, an execution engine, a user interface (UI) engine, a promo engine, a sentiment engine, and the like may be employed. These engines may seek and gather information about events from remote data sources and control functionality locally and remotely.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

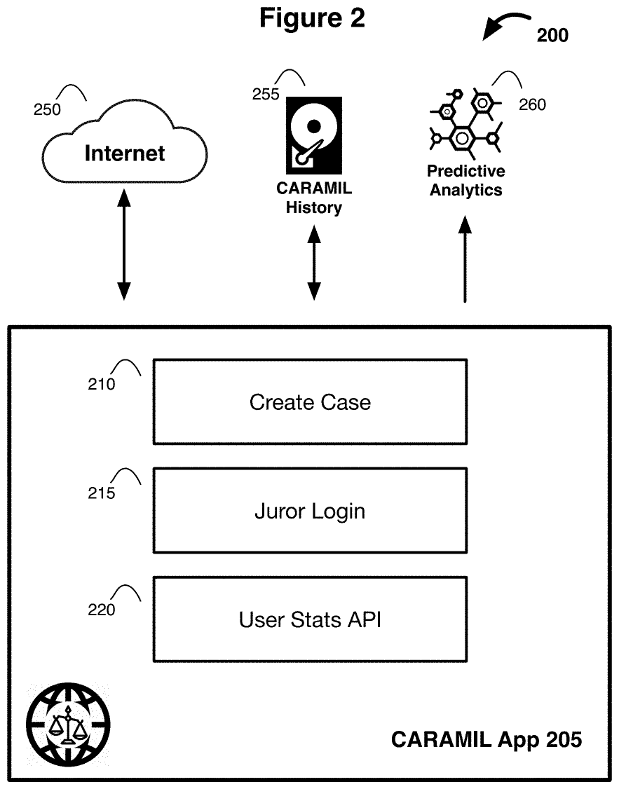

FIG. 2 illustrates a mobile application to allow users to interact with the conflict arbitration and resolution anticipation through machine intelligent learning, according to one embodiment of the current disclosure. CARAMIL App Interaction Scheme 200 allows for interaction between CARAMIL App 205, Internet 250, CARAMIL Storage 255 and Predictive Analytics 260. CARAMIL App 205 receives case data from Internet 250.

By way of example and not limitation, case data may include the following: case issue, complainant dialog, respondent dialog, complainant-favorable suggestion, respondent-favorable suggestion, evidence, witness dialogues, jury selection, and/or deliberation duration. In one embodiment, a case issue may refer to case argument data and/or user submitted content.

CARAMIL App 205 also passes case data to CARAMIL Storage 255 and Predictive Analytics 260. In one embodiment, case data takes the form of data tables disclosed herein.

CARAMIL app 205 consists of, by way of example and not limitation, case creation script 210, juror login 215 and user stats API 220. Case creation script 210 is an in-app action that allows a user of CARAMIL App 205 to create a new case. For example, a person (complainant) may have an aggrievance with another and have difficulty finding a resolution. One option the complainant may pursue is to use embodiments disclosed herein and log in to CARAMIL App 205 and create a case using case creation script 210.

In one embodiment, case creation script 210 may create a case data table including headings, by way of example and not limitation, case identification number, user identification number, transcript type, jury deliberation time period, case issue. An example follows in Table 2.1, provided below.

TABLE 2.1
Simplified Case Data Table Example

| Case Id | User Id | Time | Case Issue |
|---|---|---|---|
| 11 | 1e5e1 | 24 hr | Roommate drinking problem |

Further details on case data tables are provided herein. CARAMIL App 205 also includes juror login 215. Juror login 215 is an in-app action that allows users to view, comment, and/or vote on cases. In one embodiment, CARAMIL App 205 users may select this action. In this embodiment, these users may receive a list of cases in deliberation that the users may be a match for. In one embodiment, the list of cases received by the user is based on, by way of example and not limitation, one or more of the following: jury selection filters, complainant and/or respondent data or case data.

When a user selects on a case, a user may read through the case data. In one embodiment, complainant, respondent, and jury user names may be anonymous) and may choose to comment or vote on case. When a vote and/or comment are logged, the information may be stored (e.g., in jury selection 330 and or CARAMIL Storage 255).

When deliberation time is up the “vote” script may take all votes that matched the jury selection filters and may calculate to determine a winner. Finally, CARAMIL App 205 includes user stats API 220, which may, in one embodiment, keep score of the users wins and lose and compare against other application users. In one embodiment, user statistical data is stored in a user history database described herein.

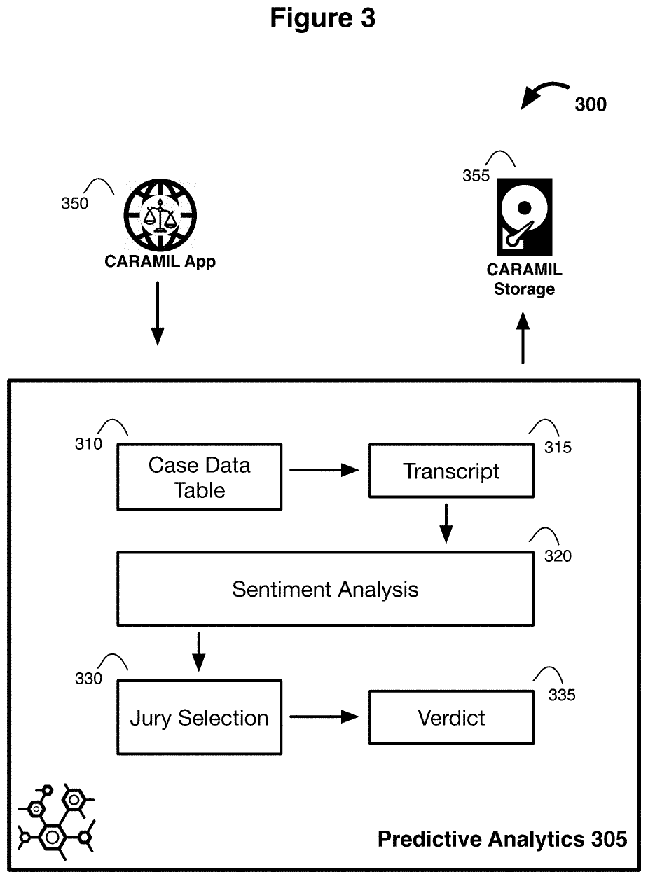

FIG. 3 illustrates predictive analytics used in natural language processing for attempting prediction of jury verdicts, according to one embodiment of the current disclosure. Predictive analytics interaction scheme 300 includes predictive analytics 305, CARAMIL App 350 and CARAMIL Storage 355.

CARAMIL App 350 may pass the case data table to predictive analytics 305. After processing, predictive analytics 305 may pass data to CARAMIL Storage 355. Predictive analytics 305 contains case data table 310, transcript 315, sentiment analysis 320, jury selection 330 and verdict 335.

Case data table 310 may be a boolean operation script that may verify that all fields in case data 310 have inputs. This script may validate input fields, for those fields that have data will be flag “true” and missing inputs “false.”

Transcript 315 may be a script that verifies the case communication medium e.g. text, audio, and/or video. In one embodiment, transcript 315 is configured to accept text only cases. In this embodiment, transcript 315 may scan through case data 310 and may validate that all text are strings (a sequence of characters). Transcript 315 may add a new column to a simple example of a case data table, as provided in Table 3.1, below.

TABLE 3.1
Transcript Type

| CaseID | transcriptType |
|---|---|
| 13 | Text |

Sentiment analysis 320 may take a word from case data 310 and assign a score based on sentiment analysis of that word. In one embodiment, the sentiment score may range on a scale of “one” to “five,” wherein a score of “one” is “calm,” and “five” is “angry.” In one embodiment, sentiment analysis may occur by first performing etymological analysis of a word and determining that word's root. Each word from case data 310 may be analyzed in this manner and may be stored in case data 310. In one embodiment, the sentiment score is added to the case data table as a new column, “sScore,” as provided below in Table 3.2.

TABLE 3.2
Sentiment Score “sScore”

| userId | caseKeyword | wordType | sScore |
|---|---|---|---|
| 101 | Cheap | adjective | 3 |

Next, the list of words/roots may be parsed through and words/roots related to emotion may be flagged. Afterwards, if the word/root combination is flagged, sentiment analysis may be performed as described above, based on the word and root. In addition, the polarity of the flagged word/roots may be determined. This determination may be made on a scale including positive, neutral or negative. This data may be stored in case data table 310, and is shown in Table 3.3, provided below.

TABLE 3.3
Polarity Score

| userId | caseKeyword | wordType | sScore | Pos/Neg |
|---|---|---|---|---|
| 101 | Cheap | adjective | 3 | Neg |

Note, sentiment analysis and other methods are described in greater detail herein. An example of sentiment analysis such as that occurring in sentiment analysis 320 is provided below. In this example, we will use the following keywords from a case: “You,” “think,” “I'm,” “being”, “cheap.”

In one embodiment, a first algorithm may flag each word to an emotional state. By way of example and not limitation, emotional states may include: “curious,” “relaxed,” “fearful,” “inspired,” and the like. Using an example of the word “cheap” from the case data table, we will use the first algorithm may assign an emotional state of resentful. In a further embodiment, another algorithm may perform sentiment analysis on the word “cheap,” assigning a sentiment score of 3. In a further embodiment, we will perform a polarity determination based on the word “cheap” and the root of the word “cheap.” In this embodiment, the polarity determination returns with a polarity of “negative.” As a result, case data table 310 may, by way of example and not limitation, look similar to Table 3.4, provided below.

TABLE 3.4
Case Data Table Entry for “cheap”

| userId | caseKeyword | wordType | sScore | Pos/Neg |
|---|---|---|---|---|
| 101 | Cheap | adjective | 3 | Neg |

It is worth noting that sentiment analysis may be performed on jury comments delivered during jury deliberation. In other words, jury users may add comments to cases during deliberation. In one embodiment, CARAMIL may parse these comments for all cases and may utilize sentiment analysis 320 script to analysis the data. This data is added to the table and stored in databases mentioned herein.

in one embodiment, jury selection 330 may tag all votes that meet the jury criteria. In a further embodiment, jury selection 330 may include selection filters that are assigned to a case by the complainant and respondent. By way of example and not limitation, selection filters may include demographics such as age, gender, city, etc. Jury selection 330 may add a jury criteria as additional columns to the data table, such as an age range and a gender. These are as shown in Table 3.5 in the form of jury criteria.

TABLE 3.5
Jury Criteria

| caseId | userVote | juryCritera_a | juryCriteria_b |
|---|---|---|---|
| 13 | Complainant | age: 23-33 | gender:woman |

In one embodiment, jury selection 330 may operate as follows: when the complainant creates a case, the complainant may specify jury restrictions. In one embodiment, these jury restrictions may function as jury selection filters. In this embodiment, these jury selection filters may be presented to CARAMIL users as clickable radio buttons (e.g. on/off) to determine which users have access to vote.

In one embodiment, jury selection 330 may collect case votes and may verify that all votes meet the selection filter requirements. Then case data gets passed to verdict 335.

Verdict 335 may be a script that collects the votes and totals the votes. Results may be stored and sent to verdict records in a storage system (such as, by way of example and not limitation, CARAMIL Storage 165 or Cloud Storage 125, or verdict records 520, described herein). An example of tallied votes follows in Table 3.6, provided below.

TABLE 3.6
Verdict by Jury Votes

| userId | caseId | userVote | totalVotes |
|---|---|---|---|
| 101 | 56 | Complainant | 150 |
| 102 | 56 | Respondent | 65 |

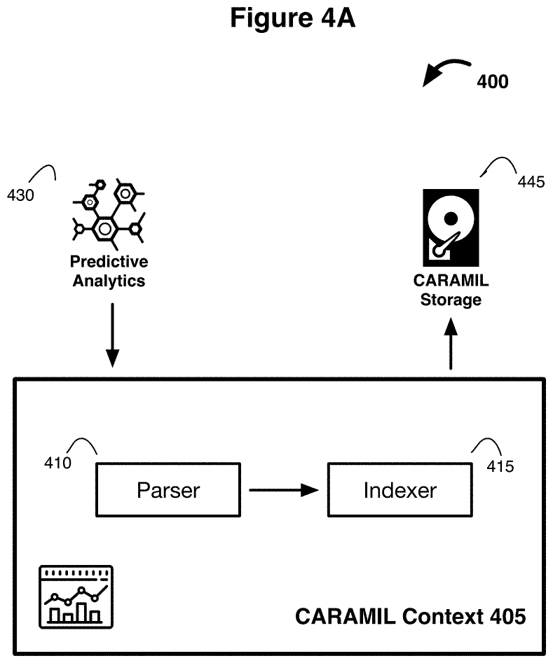

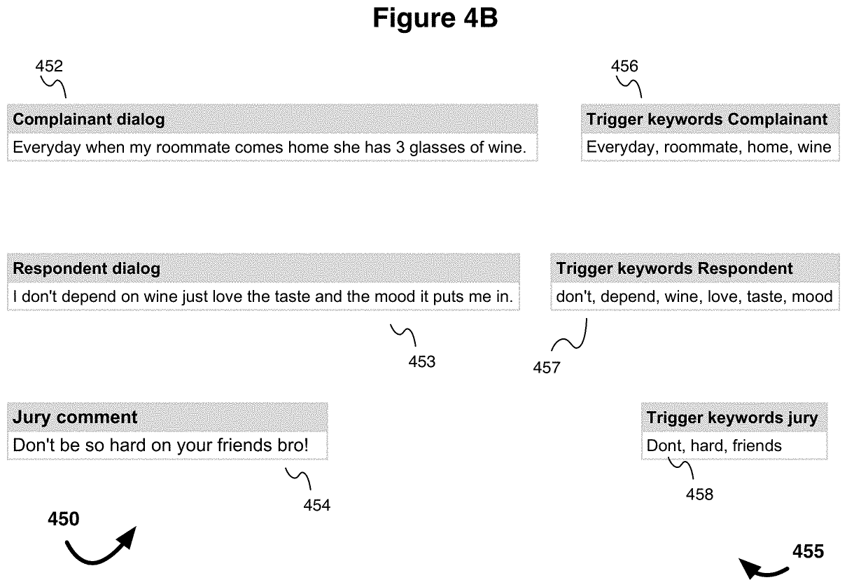

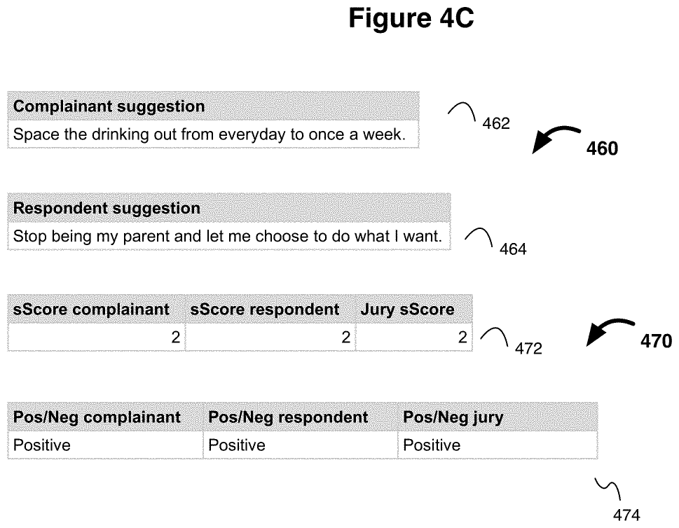

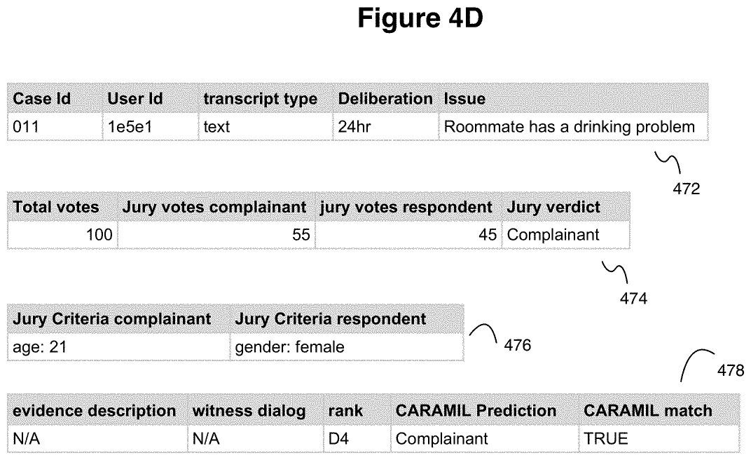

FIGS. 4A, 4B, 4C and 4D illustrate processing of trial context data and case data table elements, according to one embodiment of the current disclosure. In FIG. 4A, CARAMIL Context Interaction Scheme 400 includes CARAMIL Context 405, Predictive Analytics 430 and CARAMIL Storage 445. CARAMIL Context 405 passes the case data table into Predictive Analytics 430. In one embodiment, case data table may include, by way of example and not limitation, one or more of the following: data from transcripts 315, sentiment analysis 320, jury selection 330, and verdict 335, as displayed in Tables listed herein.

CARAMIL Context 405 stores data into CARAMIL Storage 455. In one embodiment, case data table may include, by way of example and not limitation, one or more of the following: data from transcripts 315, sentiment analysis 320, jury selection 330, and verdict 335, as discussed in Tables listed herein. An expansive treatment of case table data is given in FIGS. 4B-D and elsewhere herein.

Parser 410 may be a case memory script that may extract case data from case data table and rearrange the data by column. By way of example and not limitation, column data may include the following: user identification data, sentiment data, verdict data, case keyword data, and other data discussed herein.

Indexer 415 may receive the data table from parser 410 and then may store case data table into case history (not shown) in CARAMIL Storage 445. In addition, indexer 415 moves archives of case data from parser 410 into CARAMIL Storage 445. In one embodiment, indexer 415 takes organized columns parsed by parser 410 and moves said columns to appropriate databases within storage system 500, discussed herein. In this embodiment, case data such as case identification and other case data described herein may be arranged by columns.

In FIG. 4B, dialog elements 450 include complainant dialog 452 and trigger words 455. In one embodiment, dialog elements 450 include complainant dialog 452, respondent dialog 453, jury comment 454, which may represent user text from a case entered into CARAMIL. Complainant dialog 452 may refer to dialog entered by the complainant, by way of example and not limitation, this dialog may be the original complaint submitted by the complainant. Respondent dialog 453 may refer to dialog entered by the respondent, by way of example and not limitation, this dialog may be the original response submitted by the respondent. Finally, jury comment 454 may be a comment entered in by a jury user during deliberation, by way of example and not limitation, in response to other user text in an active case.

Further in FIG. 4B, trigger words 455 complainant trigger words 455, respondent trigger words 456, and jury trigger words 457.

In one embodiment, complainant trigger words 455 may be words known to have emotional content or connotations, Thus, complainant trigger words 455, respondent trigger words 456 and jury trigger words 457 refer to complainant, respondent and jury text content with emotional content (respectively). It is important to note that lexical matrices (mentioned herein) may have their base structure (i.e. “roots”) in strings of trigger words and their synonyms.

In FIG. 4C, suggestions 460 include complainant suggestion 462 and respondent suggestion 464. In one embodiment, complainant and respondent may make suggestion to resolve the conflict between complainant and respondent. Similar to that in civil suits, it is likely that the suggestions made by each party will be favorable to that party. Thus, complainant suggestion 462 and respondent suggestion 464 may be suggestions favorable to complainant and respondent, respectively. Further in FIG. 4C, scoring scores 470 includes sentiment scoring 472 and polarity scoring 474.

Sentiment scoring 472 is the result of sentiment analysis upon one or more collections of complainant text, respondent text and/or jury text. By way of example and not limitation, a complainant, respondent or jury user may enter in dialogue and/or commentary upon which sentiment analysis is run by embodiments disclosed herein. Sentiment analysis is described in greater detail herein.

Polarity scoring 474 is the result of a polarity check upon one or more collections of complainant text, respondent text and/or jury text. By way of example and not limitation, a complainant, respondent or jury user may enter in dialogue and/or commentary upon which Polarity scoring is run by embodiments disclosed herein. Polarity scoring is described in greater detail herein.

FIG. 4D includes primary case data 472, voting/verdict data 474, jury criteria 476 and auxiliary case data 478. Primary case data 472 includes case identification which allows for identification of the case, by way of example and not limitation, a unique alphanumeric handle. Primary case data 472 also includes a user identification

In one embodiment, a user identification may be associated with user metadata. For example, user joins CARAMIL through a social networking platform (e.g. Facebook, Twitter, etc.) and CARAMIL pulls data about the user through the user's account with the social networking platform. A user data table may be created to store this metadata and this table may be linked to the user's ID.

Primary case data 472 also includes a “transcript type.” In one embodiment, transcript type refers to the type of data input by CARAMIL users. In a further embodiment, this data type may be ASCII text only. In other embodiments, input data may take the form of audiovisual media as known. The inventor contemplates any and all data types used.

Primary case data 472 also includes a jury deliberation period that specifies jury deliberation, by way of example and not limitation, a time period or until certain conditions may be met. Primary case data 472 also includes a case issue, which may be the issue that the complainant and respondent parties hold in contention

Voting/verdict data 474 includes the total number of possible jury votes, here, by way of example and not limitation, 100. Voting/verdict data 474 also includes votes in favor of the complainant, here, by way of example and not limitation 55 of the 100 total votes. Voting/verdict data 474 also includes votes in favor of the respondent, here, by way of example and not limitation 45 of the 100 total votes. Voting/verdict data 474 also includes the victor by number of votes, here, by way of example and not limitation, the complainant by a margin of 10.

Jury criteria 476 includes criteria specified by the complainant (by way of example and not limitation, an age of 21) and respondent (by way of example and not limitation, female jury members).

Auxiliary case data 478 includes evidence description, which may refer to the type of evidence submitted. In one embodiment, evidence may take the form of witness text input. In other embodiments, evidence description data may take the form of audiovisual media as known. By way of example and not limitation, evidence descriptions could include “the parking ticket” or “picture of the dent you put in my car.” The inventor contemplates any and all data types used.

Auxiliary case data 478 includes an optional witness dialog in which witnesses for the complainant or respondent may submit commentary. Importantly, sentiment analysis and polarity scoring may be run on any text processed by embodiments disclosed herein, including witness dialog.

Auxiliary case data 478 includes rank, which, in one embodiment, may be the results of an direct or indirect match as described herein. In one embodiment, rank may be defined as the combination of a direct or indirect synonym match as well as a numerical score, (e.g., 1-5) showing the proximity of the match between synonyms. By way of example and not limitation, rank is shown as D4, which may refer to a 4th degree direct match.

Auxiliary case data 478 includes prediction, which may be a prediction as to the verdict by embodiments disclosed herein. By way of example and not limitation, CARAMIL pre

Auxiliary case data 478 includes match, which may be the result of the prediction by embodiments disclosed herein against the actual outcome by the jurors.

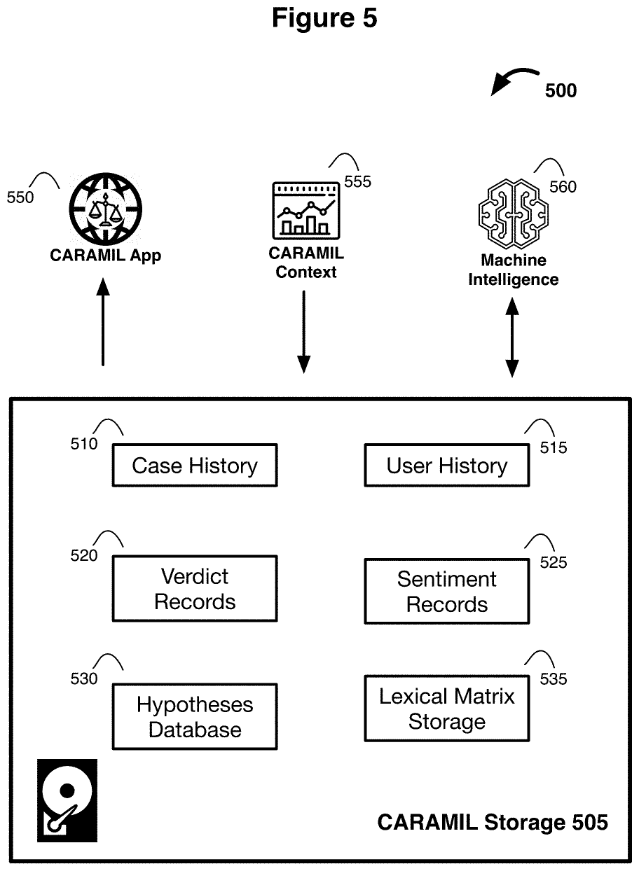

FIG. 5 illustrates data storage information, according to one embodiment of the current disclosure. CARAMIL Storage Interaction Scheme 500 includes CARAMIL Storage 505, CARAMIL App 550, CARAMIL Context 555 and Machine Intelligence 560. Furthermore, CARAMIL Storage 505 includes case history 510, user history 515, verdict records 520, sentiment records 525, hypotheses storage 530 and lexical matrix storage 535.

As discussed in FIG. 4, indexer 415 moves data into CARAMIL Storage 505. In one embodiment, indexer 415 may receive case data table from parser and may move columns of data as follows: sScore data from data table x may be moved into sentiment records 525; Case identification data may be moved into Case History 510; User identification data may be moved into User History 515; Transcript Type may be moved into Case History 510; Deliberation time may be moved into Case History 510; Issue may be moved into Case History 510; Complainant dialog may be moved into Case History 510; Respondent dialog may be moved into Case History 510; Trigger keywords Complainant may be moved into Case History 510; Trigger keywords Respondent may be moved into Case History 510; sScore complainant may be moved into Sentiment Records 525; sScore respondent may be moved into Sentiment Records 525; Pos/Neg complainant may be moved into Sentiment Records 525; Pos/Neg respondent may be moved into Sentiment Records 525; Jury Criteria complainant may be moved into Case History 510; Jury Criteria respondent may be moved into Case History 510; Complainant suggestion may be moved into Case History 510; Respondent suggestion may be moved into Case History 510; Total case votes may be moved into Verdict Records 520; Jury votes complainant may be moved into Verdict Records 520 Jury votes respondent may be moved into Verdict Records 520; Trigger keywords Jury may be moved into Case History 510; Jury sScore may be moved into Sentiment Records 525; Pos/Neg Jury may be moved into Sentiment Records 525; optionally, evidence description may be moved into Case History 510 and optionally: witness dialog may be moved into Case History 510. Lexical matrices generated (as described herein) may be stored in lexical matrix storage 535.

CARAMIL Storage 505 may transfer case data to CARAMIL App 550. In one embodiment, case data may include a case identification number, and if a CARAMIL user requests a specific case, CARAMIL may pull that case by the case identification number. In this manner, CARAMIL Storage 505 may transfer any data held within CARAMIL Storage 505 to CARAMIL App 550. In one embodiment, CARAMIL Context 555 may transfer similar case data to CARAMIL Storage 505 in a manner similar to the above.

In an additional embodiment, CARAMIL Storage 505 exchanges case data with Machine Intelligence 560. This exchange of case data is described in greater detail herein. In a further embodiment, CARAMIL Storage 505 stores data in other locations such as, by way of example and not limitation, Internet 105, server storage, or cloud storage 125.

CARAMIL Storage 505 includes case history 510, user history 515, verdict records 520, and sentiment records 525. Case history 510 stores archives of case data from indexer 415. User history 515 stores archives of case data from indexer 415. Verdict records 520 stores archives of case data from verdict 335. Sentiment records 525 stores archives of case data from sentiment analysis 320. Hypothesis storage 530 may contain hypotheses and associated occurrence probabilities.

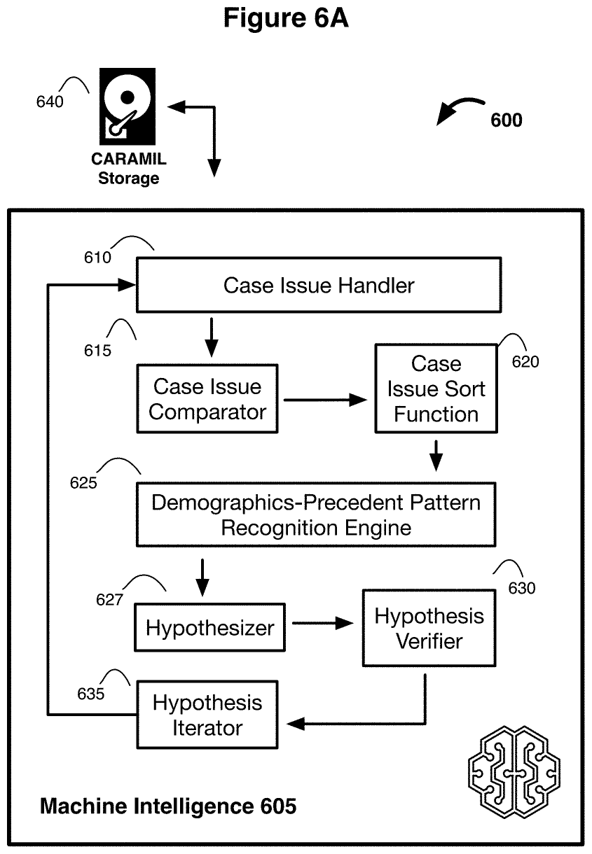

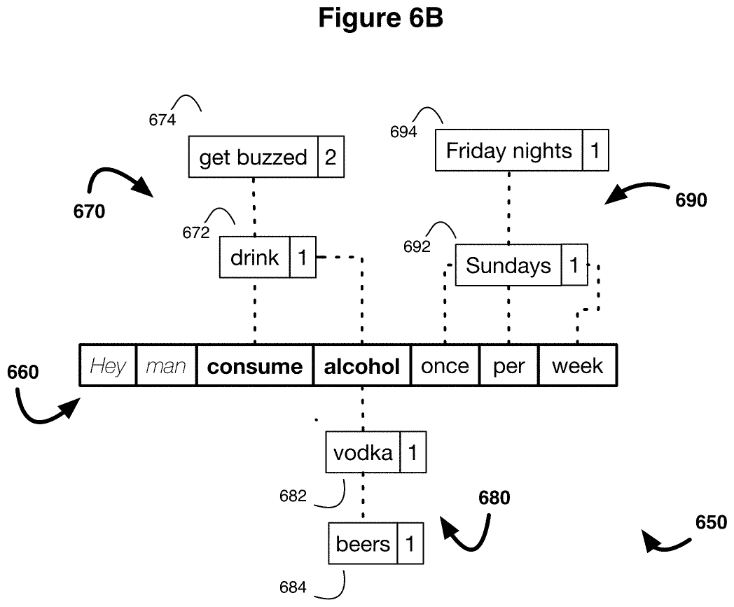

FIGS. 6A and 6B illustrate the stages for refinement of a machine intelligence and a lexical matrix, according to one embodiment of the current disclosure.

Machine Intelligence Interaction Scheme 600 includes Machine intelligence 605 and Caramil storage 640. In one embodiment, Machine intelligence 605 processes data in Caramil storage 640 and returns processed data to Caramil storage 640.

Machine intelligence 605 includes case issue handler 610, case issue comparator 615, case issue sorter 620, demographics-precedent pattern recognition engine 625, hypothesizer 627, hypothesis verifier 630 and hypothesis iterator 635.

In one embodiment, an issue may be the core of aggrievances by complainants such as personal property damage (e.g. vehicular accidents) or personal disputes (e.g. how a sensitive topic was handled between the complainant and the respondent).

### Case Issue Handler

Case issue handler 610 may scan cases from CARAMIL Storage 505, may collect all issue types and may match like case issues into groups. Using the example of “roommate using vodka to manage stress” as the issue type, case issue handler 610 may scrape databases mentioned herein for case issues (e.g. from CARAMIL Storage 505). Case issue handler 610 may then collect issue types that have issues that may be similar to alcoholism. Further in this example, once all known alcoholism issue types may be found, related data may be stored into a database. This database may be stored in CARAMIL Storage 505.

### Case Issue Comparator

In one embodiment, case issue comparator 615 is a subroutine of case issue handler. In this embodiment, case issue comparator 615 may pull case issue text and determine similarities based on a natural language processing algorithm that utilizes a sentiment recognition system. In a further embodiment, case issue comparator 615 may output a direct or indirect percentage-match between two or more case issues. Further still in this embodiment, case issue comparator 615 may rank two or more case issues similar to the issue of the case currently under analysis. Case issue comparator 615 is described in greater detail herein. In addition, natural language processing algorithms that may be employed by case issue comparator 615 may be described in methods and figures herein.

### Case Issue Sorter

Case issue sorter 620 may access a database (e.g. case history 510) and may mark matching case issues and case data into a common case category i.e. “alcoholism.” Case issue sorter 620 may receive output from case issue comparator 615 and, based on synonyms, create combinations of words to use as case issue containers to enclose cases with similar issues into a database. This database may be in CARAMIL Storage 505.

### Demographics-Precedent Pattern Recognition Engine

In one embodiment, user data and user-suggested solutions may follow trends that may be useful in anticipating future solutions. By way of example and not limitation, user data may take the form of one or more of complainant, respondent and/or jury demographics.

Also by way of example and not limitation, user-suggested solutions may take the form of complaint- or respondent-favorable solutions, or even jury-suggested solutions. Such solutions may be referred to herein as precedent.

As mentioned above, demographics (i.e., user data) and precedent (i.e., solutions) may follow trends that may be useful in anticipating a solution to a case currently under analysis by machine intelligence 605. In one embodiment, such “trend spotting” may be accomplished by demographics-precedent pattern recognition engine 625, also referred to as DPPRE 625.

DPPRE 625 may parse through case categories and user demographics relationships between complainant- and respondent-favorable suggestions of from past cases to identify patterns between types of users and similar solutions frequently suggested by users within that type.

As mentioned herein, sentiment analysis may also be performed on jury commentary delivered during deliberation. The results from this sentiment analysis may provide additional insight for DPPRE 625.

Pattern Recognition Using “k-NN Algorithm”

In one embodiment, pattern recognition is performed using a “K-nearest neighbors” (k-NN) algorithm. In a k-NN algorithm, the variable “K” reflects a degree match based on text string proximity. In other words, a first, second, third, etc. degree of similar between text strings may be chosen by altering the value “K.”

k-NN algorithms may function as follows: a first data table may be consumed. In one embodiment, this data table may be a training data table. Next, a set of test data is predetermined. Next, similarities nay be queried between test data and training data using a distance measurement function shown in Equation 6.1, below.

d_{(q,p)}=\sqrt{(q₁−p₁)²+(q₂−p₂)²} Equation 61:

A description of variables is provided as follows. In one embodiment, q may be a complainant sentiment score, p may be the respondent sentiment score. And d (or K) may be the output of the equation which represents a “distance” in the form of a square root of the sum of squared differences of other sentiment scores. In one embodiment, distance d may vary only between one and five if complainant and respondent sentiment scores range only between one and five. In a further embodiment, distance d represents a correlation proximity between words, strings, numbers and other values.

Note that the distance measurement function is a polynomial with n-terms. Afterwards, the output, or class, of test data is predicted. In one embodiment, queries may be run to search for data (e.g. verdict results) by sScore for either/or complainant or respondent. By way of example and not limitation, CARAMIL allows for searches of verdict history matching overall sentiment from a complainant or respondent user by entering in to CARAMIL, effectively, how “calm” or how “angry” the complainant or respondent were during their case. More specially, a sentiment analysis request with a sentiment score from range 1 (“calm”) to 5 (“angry”) may be entered to determine past verdicts matching these sentiment scores. Additionally, case history data associated with those histories can also be pulled for further examination. In one embodiment, DPPRE 625 may perform similar to the above example. Fist, case issue sorter 620 may pass all case data related to the issue of the case currently under analysis. By way of example and not limitation, this issue may be “alcoholism.” Next, predetermined test data wherein the complainant and respondent sentiment scores may be 5 is entered into the k-NN algorithm, as shown in Table 6.1, below.

TABLE 6.1
Predetermined Test Data

| Case Id | Complainant sScore | Respondent sScore | Verdict |
|---|---|---|---|
| 0 | 5 | 5 | ? |

The purpose of entering data in this manner is to determine what the verdict should be. An initial data set is provided below.

TABLE 6.1
Initial Data Set

| Case Id | Complainant sScore | Respondent sScore | Verdict |
|---|---|---|---|
| 11 | 2 | 2 | Complainant |
| 12 | 3 | 4 | Complainant |
| 13 | 3 | 5 | Respondent |

Here, this sScore is the result of a sentiment analysis of, potentially, all the complainant's and/or respondent's text, distilled into a 1-5 scoring using an averaging algorithm or a k-NN algorithm. Next, the test dataset is taken and entered into the distance formula in order to perform query similarities. Distances may be then calculated.

TABLE 6.2
Query Similarities

| Case Id | C sScore | R sScore | Verdict | Distance |
|---|---|---|---|---|
| 11 | 2 | 2 | C | √[(2-5)² + (3-5)²] = 3.60 |
| 12 | 3 | 4 | C | √[(2-5)² + (4-5)²] = 3.16 |
| 13 | 3 | 5 | R | √[(3-5)² + (4-5)²] = 2.23 |

Since distances have been solved, d values can be entered in order to search for values (e.g. values, strings of text, etc., values considered “neighbors” in the k-NN algorithm) within that d range. Again, d refers to the degree match to the target word, i.e. a distance value where a greater distance represents a weaker relationship between the target word and the synonym suggested. Table 6.3, provided below, reflects this data.

TABLE 6.3
Rank NN (Nearest Neighbor):

| | Complainant | Respondent | | | Rank NN |
|---|---|---|---|---|---|
| Case Id | sScore | sScore | Verdict | Distance | (K value) |
| 11 | 2 | 2 | C | 3.60 | 3 |
| 12 | 3 | 4 | C | 3.16 | 2 |
| 13 | 3 | 5 | R | 2.23 | 1 |

Finally, the above data may be distilled into a prediction as follows: “If the Complainant sScore and Respondent sScore both equal 5, in an alcoholism case, the verdict predicted by CARAMIL will be for Respondent.

### Hypothesizer

Hypothesizer 627 creates hypotheses in response to patterns DPPRE 625 recognizes. A hypothesis is an rule proposed by machine intelligence 605 based on previous patterns that may hold true in future cases. Such a hypothesis may form the basis of increasingly advanced and accurate predictions put forth by machine intelligence 605. In one embodiment, a hypothesis may be the result of distillation of CARAMIL user suggestions to a core meaning using a lexical matrix, explained below and herein.

User suggestions may take many forms, but similarities can be drawn between suggestions in a way that minimizes loss of meaning, but allows for efficient grouping of suggestions. In the same vein as other examples herein referring to alcoholism, some users may provide suggestions in the form of “drink less,” “drink once per week” or “drink one drink on Saturdays.” Arguably, all of these suggestions may fall under the category of “drink in moderation.” However, some meaning may be lost since some suggestions contain a recommend alcohol dosage and others do not.

Interestingly, suggestions may effectively have near or perfect equivalents such as “drink once per week” and “drink only on Saturdays,” “consume alcohol only on Friday nights” as well as “have beers on Sundays.” All of these examples may be may be distilled to “the suggested frequency of drinking is one time per week” without loss of meaning.

The question addressed now is how to efficiently capture all of these suggestions with minimal loss of meaning. In one embodiment, these can be achieved with a lexical matrix. In one embodiment, a lexical matrix may be a type of “sentence” formed wherein one array may contain cells with “root” word or words that represent a user suggestions, and each cell may be related to another array of neighboring synonyms. In a further embodiment, the distance from the root word(s) may reflect the degree of relationship with neighboring synonyms and the root word(s), similar to that used in a k-nearest neighbors (kNN) algorithm. Thus, in one embodiment, hypothesizer 627 generates hypothesis by distilling multiple user suggestions into lexical matrices referred to herein as hypotheses.

The relationships between lexical matrices and the users that made the suggestions that formed the lexical matrices may be valuable. Specifically, the demographical groups can be correlated with the suggestions given by those groups, and in turn, lexical matrices generated by those suggestions. This correlation is performed by a demographics-precedent pattern recognition engine (DPPRE) executed by a machine intelligence.

Importantly, this correlation formed by a DPPRE may be used to predict how a user that fits a demographical group associated with previous suggestion lexical matrices may vote in the future. In other words, a machine intelligence equipped with a DPPRE may be able to learn how a user who fits a demographical group may vote in the future regardless of whether any prior voting history or other data has been collected on that user. In this manner, even a user with little data associated with that user (other than demographical data about that user) may have their vote or solution anticipated by such a machine intelligence.

By way of example and not limitation, four hypotheses that may be generated by embodiments disclosed herein are provided.

Hypothesis #1: If jury member (age=21 & currently enrolled in college), then jury member will have lower sentiment towards alcohol

Hypothesis #2: If jury member (age<40 & female & has 1 child) or (member of mothers against drunk driving), then jury member will have higher sentiment towards alcohol.

Hypothesis #3: If jury member is (member of alcoholics anonymous), then jury member will have higher sentiment towards alcohol.

Hypothesis #4: If jury member is (police officer), then jury member will have higher sentiment towards alcohol.

These four hypotheses, including the probability that the hypothesis will occur, may be arranged as shown in Table 6.4, below.

TABLE 6.4
Four Test Hypotheses

| | Hypotheses | Occurence Probability |
|---|---|---|
| 1 | (Age 21) && (enrolled in college) | 70% |
| 2 | (Age <40 && 1 child) \|\| (member of MADD) | 80% |
| 3 | Member of Alcoholics Anonymous | 80% |
| 4 | member of police force | 60% |

Note, in one embodiment, a hypothesis may be generated with a zero or undefined occurrence probability, as described herein. In another embodiment, probability may be defined as how often this result holds true when the hypothesis is compared against a verdict.

As cases are entered into CARAMIL and new hypotheses may be generated and tested, occurrence probability values may be adjusted accordingly, thereby refining the machine intelligence. Note also, that in one embodiment, lower sentiment, such as 1 or 2, is positive, higher sentiment, such as 4 or 5 is negative.

### Hypothesis Verifier

Hypothesis verifier 630 may test hypotheses from hypothesizer 627 against a case currently under analysis by machine intelligence 605 and make predictions as to the outcome of the case (i.e., the verdict).

In one embodiment, hypothesis verifier 630 may take, by way of example and not limitation, one or more of the following: case issue, voter demographic data, solutions, and sentiment score to determine an outcome. In one embodiment, hypothesis verifier 630 may take the form of an algorithm that test these rules against new case specific to the case category (e.g., “alcoholism”) and make predictions as to the verdict.

Continuing in the same vein as the example from above, the four hypotheses generated above may be verified by hypothesis verifier 630. Furthermore, after verification, the probability of the four hypotheses may be altered based on the comparison of the hypothesis and the actual case outcome (as decided by jury members). A continuation of the example follows.

A new case, case ID 14, is added.

TABLE 6.4
Rank NN (Nearest Neighbor):

| Case Id | Complainant sScore | Respondent sScore | Verdict |
|---|---|---|---|
| 11 | 2 | 2 | Complainant |
| 12 | 3 | 4 | Complainant |
| 13 | 3 | 5 | Complainant |
| 14 | ? | ? | ? |

(1)

Then, hypothesis verifier 630 will compare the rules from hypothesizer 627 against case ID 14.

TABLE 6.5
Verification of Four Test Hypotheses

| | Hypothesis Details | Accuracy |
|---|---|---|
| 1 | (Age 21) && (enrolled in college) | 0 |
| 2 | (Age <40 && 1 child) \|\| (member of MADD) | 1 |
| 3 | Member of Alcoholics Anonymous | 0 |
| 4 | member of police force | 0 |

The result of this out come is that only 1 out of 4 rules were held true, and the prediction that was made in favor of the alcoholism was false.

### Hypothesis Iterator

In this manner, hypothesis iterator 635 may adjust the probability on the results of hypothesis verifier 630. Thus, machine intelligence 605 may be further refined.

TABLE 6.6
Iterated Probability of Four Test Hypotheses

| | Hypothesis Details | Accuracy | Probability |
|---|---|---|---|
| 1 | (Age 21) && (enrolled in college) | 0 | 69% |
| 2 | (Age <40 && 1 child) \|\| (member of MADD) | 1 | 81% |
| 3 | member of Alcoholics Anonymous | 0 | 79% |
| 4 | member of police force | 0 | 59% |

In one embodiment, probability may be calculated and iterated as follows. A probability may initially calculated as a number of cases divided by total number of cases, as shown in Equation 6.1.

Probability=(Accurate hypothesis outcomes)/(Total number of cases) Equation 6.1

In this manner, hypothesis iterator may start with a beginning probability. In addition, a probability may be iterated in at least two different ways: one in where the hypothesis proved correct and another in which the hypothesis proved incorrect. In the case of a correct hypothesis, the probability will be increased, as shown in Equation 6.2.

Probability=(Accurate hypothesis outcomes+1)/(Total number of cases+1) Equation 6.2

In one embodiment, the total number of cases is assumed to be greater than or equal to the number of accurate hypothesis outcomes. In this manner, the accuracy cannot exceed 1.0 (100%).

If the hypothesis fails upon testing, the probability is decreased to reflect this outcome, as shown in Equation 6.3.

Probability=(Accurate hypothesis outcomes)/(Total number of cases+1) Equation 6.3

It is important to note that embodiments disclosed herein allow for granular control of probabilities by small increments, referred to herein as delta or delta changes. These changes may be possible through, in one embodiment, individual jury vote prediction based on, by way of example and not limitation, jury demographics. An example follows.

By way of example and not limitation, assume an alcoholism case between a complainant and respondent with 100 jurors that have participated in the voting process. Note, embodiments disclosed herein may allow for any CARAMIL user to view and/or vote for a case, but not all votes may count towards the verdict. As described herein, in one embodiment, only votes from jurors whose demographics match the jury criteria as selected by the complainant and/or respondent. Thus, if only 5 jurors out of the 100 participating jurors match these criteria, then only the votes from those 5 jurors count.

The question as to how each individual juror may vote may be answered as follows. Juror metadata refers to data about juries, including but not limited to, jury demographics, and semantic and/or polarity analysis on jury commentary made at any point. Juror metadata analysis may be employed as follows.

One option is to analyze comments made by these jurors in this current case. In this example, sentiment analysis and polarity checking may be performed on, by way of example and not limitation one or more of the following: jury user comments made in this case, jury user comments made in previous cases, jury user comments made in previous cases when acting as complainants or respondents. Another option is to analyze any text data known to be associated with these users that may be available on the Internet, or publicly available on, e.g. social media sites (Facebook, Instagram, Twitter).

This data collection and prediction scheme may be further expanded to users that may not currently be part of or may be very new to CARAMIL (thus little or no known data may have been collected on them), in order to predict how these members may vote. This data may also include text that jurors may have submitted when playing the role of a complainant or respondent. In other words, this commentary and associated sentiment/polarity analysis results may be added to the jury member prediction metadata.

In this manner, as jury prediction metadata (e.g., jury demographics and previous jury comments as well as sentiment/polarity analysis on said jury comments) is accumulated on an individual juror bases, this jury prediction metadata to determine how a jury member votes.

FIG. 6B shows a sample lexical matrix demonstrating one or more of the above examples. By way of example and not limitation, lexical matrix 650 shows multiple jury-proposed solutions for alcoholism distilled into equivalent solution 660, described as “consume once per week.” Equivalent solution array 660 captures the above exemplary jury-suggested solutions to alcoholism of “drink once per week” and “drink on Sundays,” “consume alcohol only on Friday nights” as well as “have beers on Sundays.”

As mentioned herein, lexical matrices may be arrays of arrays, and in one embodiment, one array may be an equivalent solution such as equivalent solution 650, and other arrays may be attached to an equivalent solution. In one embodiment, an array that may be attached to an equivalent solution may contain an array of synonyms. It is important to note that synonyms as used herein may not be limited to a single word, as known in English grammar, but may be equivalent words or collections of words (phrases) that are equivalent to other single words or collections of words. In this embodiment, such an array containing synonyms associated with an equivalent solution may be considered a synonym array, and this synonym array may be linked to an equivalent solution at a nexus cell. This nexus cell represents a word that is part of an equivalent solution, and also shares meaning with synonyms in a synonym array. It is worth noting that, in one embodiment, the order of synonyms in a synonym array may reflect similar levels such as match degrees (described herein) or the order may be arbitrary. In further embodiments, synonym arrays may be associated with proximity arrays that contain metadata referring to the degree of similarity or match with a nexus word. In one embodiment, proximity arrays may be arrays containing a degree match, provided in FIG. 6B as numbers located near synonyms.

By way of example and not limitation, synonym “drink” 672 may be considered a 1st degree match with “consume alcohol” from equivalent solution 660, as represented by dashed lines. Further in this example, synonym “get buzzed” 674 may be considered a 2nd degree match with “consume alcohol,” as represented by way of example and not limitation, the increased physical distance between synonym “get buzzed” 674 and “consume alcohol,” and in another example, by the degree match of “2” located near “get buzzed” 674. Similarly, “alcohol” from equivalent solution 660, may have two 1st degree matches with synonym “vodka” 682 and synonym beer 684. It is important to note that due to the nuances of lexical matrix construction, multiple arrays may share nexus words. As provided in the example above, “alcohol” shares synonym relationships with synonyms “vodka” 682 and beer 684 and “consume alcohol” shares synonym relationships with synonyms “drink” 672 and “get buzzed” 674. Note that any cell, including nexus words or nexus cells, in lexical matrices provided herein, may have multiple arrays linked to them.

Finally, “once per week” from equivalent solution 660 has a deeper meaning of frequency. Thus, additional user suggestions containing synonyms “Sundays” 692 and “Friday nights” 694 may, by way of example and not limitation, share a 1st degree synonym relationship with “once per week.”

In another embodiment, bold words “consume” and “alcohol” may be considered trigger words, and light italics words “hey” and “man” may be considered filler words that may be truncated in some embodiments, such considerations made by methods described herein.

It is important to note that CARAMIL may use lexical matrices for capturing more than user suggestions; any textual string may be captured in this manner. By way of example and not limitation, one embodiment allows for hypotheses described herein may be generated and tracked in a similar manner.

In sum, through the use of techniques and methods described herein, lexical matrix 650 captures these suggestions with equivalent solution 660 “consume alcohol once per week” and attached synonym arrays with little loss of meaning.

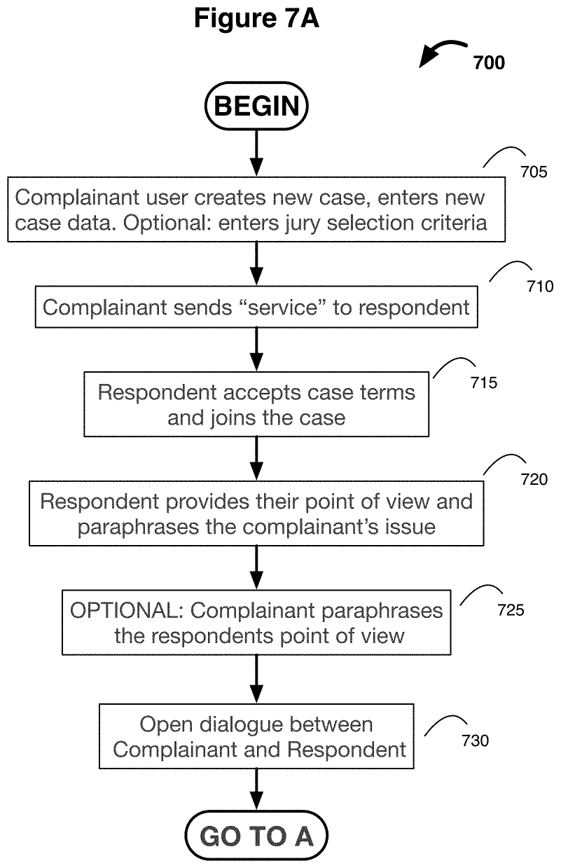

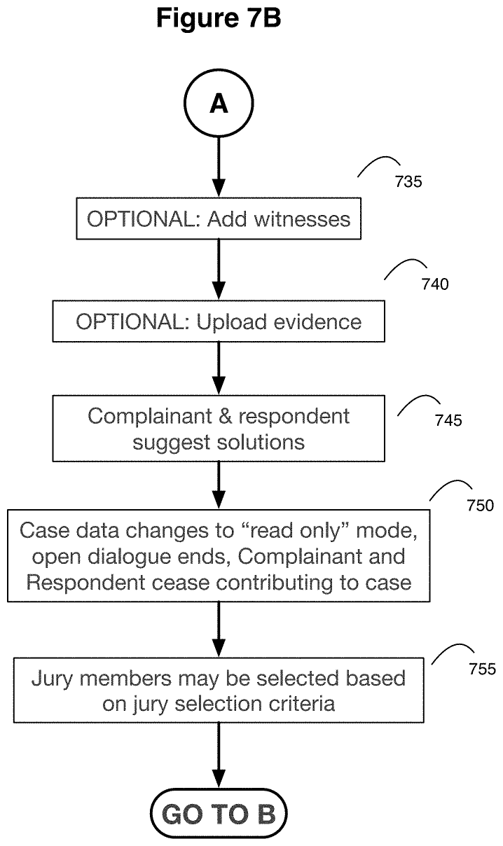

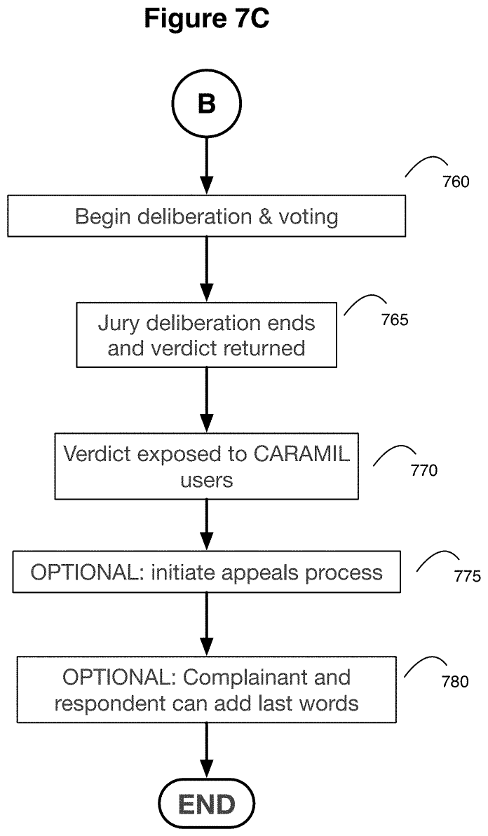

FIGS. 7A, 7B and 7C illustrate a method for case creation, according to one embodiment of the current disclosure. Although the method steps are described in conjunction with FIGS. 1-18, persons skilled in the art will understand that any system configured to perform the method steps, in any order, falls within the scope of the present invention. The steps in this method are illustrative only and do not necessarily need to be performed in the given order they are presented herein. Some steps may be omitted completely.

The method 700 begins at a step 705, a complainant user may create a new case, and enter case data. In this step, in one embodiment, the complainant user may state the issue of the case. Optionally, jury members may be selected.

At a step 710, the complainant may send “service” to a respondent user. By way of example and not limitation, service may resemble a legal “service of process” in which a defendant is notified about a pending lawsuit against him/her.

In one embodiment, service may consist of a notification sent by the application such as, by way of example and not limitation, an email or text message. The inventor contemplates any and all ways of serving or messaging Internet users known in the arts, technological, legal and otherwise. At a step 715, the respondent may accept the case terms and may join the case. In one embodiment, invitation or enticement methods described herein may be employed to have a respondent join the case. At a step 720, the respondent may provide their point of view, and optionally, paraphrase or restate the complainant's issue of the case.

At a step 725, the complainant may paraphrase or may restate the respondent's point of view. At a step 730, open dialogue may occur between complainant and respondent.

At an optional step 735, either complainant and/or respondent may add witnesses to the case. At an optional step 740, either complainant or respondent may upload evidence to a case. In one embodiment, by way of example and not limitation evidence may be audiovisual media or text. All manner of evidence is contemplated by the inventor.

At a step 755, complainant and respondent suggest solutions to the dispute. In one embodiment, these solutions may be favorable to the user suggesting them. In a further embodiment, these solutions may be referred to as “complainant- and respondent-favorable suggestions, respectively).

At a step 750, the case data may be changed to “read only” mode, and open dialogue may end, and complainant and respondent may cease contributing to case. In one embodiment, complainant, respondent or jury user identification may be anonymous. At a step 755, jury members may be selected based on, by way of example and not limitation, on or more of the following: complainant demographical data, respondent demographical data and/or case data. By way of example and not limitation, jury selection filters may include one or more of the following: age range, home city, gender, and other demographical data known in the art. In one embodiment, juror selection may occur based methods described herein.

At a step 760, jury deliberation may begin. In one embodiment, during deliberation, jury members may pore over case data, including case dialogue and may begin voting in favor of either complainant or respondent. At a step 765, jury deliberation may end and the jury may return a verdict. At a step 770, the verdict may be exposed to one or more of the following: complainant, respondent or other users.

At an optional step 775: complainant and respondent may opt to appeal the case. In one embodiment, complainant and/or respondent may be displeased with the verdict. In another embodiment, complainant and respondent may appeal the case to a higher jury board. In a further embodiment, this higher jury board may include tenured users. In one embodiment, tenured users may be “power users” that spend more than a specified time in CARAMIL either by creating cases, commenting on cases, and/or voting on cases.

At an optional step 780, complainant and respondent can add additional dialogue. In one embodiment, this additional dialogue takes the form of “last words.” In a further embodiment, these last words may allow for the complainant and respondent to react to their verdict, after which the method 700 ends.

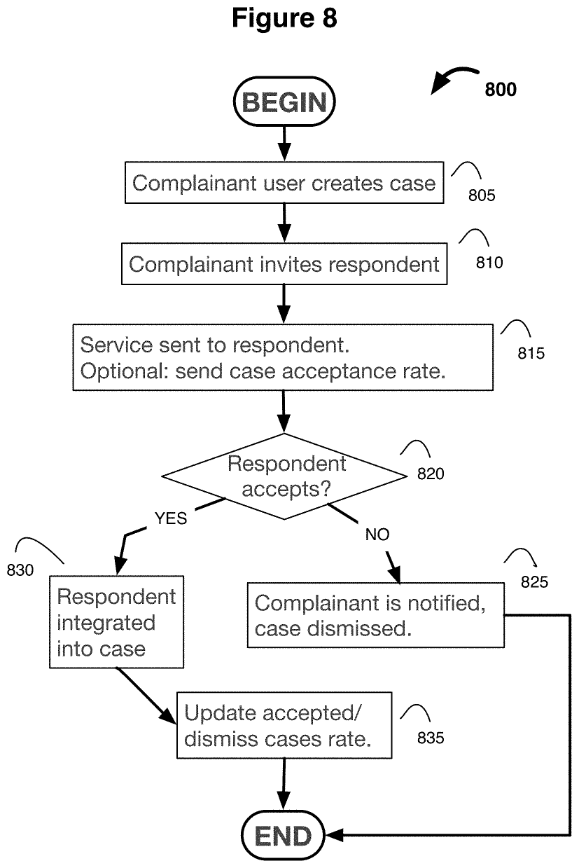

FIG. 8 illustrates a method for inviting a respondent to participate in a new case, according to one embodiment of the current disclosure. Although the method steps are described in conjunction with FIGS. 1-18, persons skilled in the art will understand that any system configured to perform the method steps, in any order, falls within the scope of the present invention. The steps in this method are illustrative only and do not necessarily need to be performed in the given order they are presented herein. Some steps may be omitted completely.

The method 800 begins at a step 805 in which complainant user may create a case. At a step 810, complainant may invite respondent. At a step 815, CARAMIL may send “service of process” message to respondent. In one embodiment, CARAMIL may send a case acceptance rate to either the respondent or complainant. In a further embodiment, the case acceptance rate may be an acceptance rate of cases by respondents in the past. At a step 820, a determination is made automatically, whether or not the respondent has either accepted or declined/ignored the invitation.

If the respondent declines the case, at a step 825, the complainant is notified and the case is dismissed, after which the method 800 ends. If the respondent accepts the case, at a step 830, the respondent is integrated into the case. At a step 835, the case accept/dismissal rate is updated, and the method 800 ends.

Embodiments of they invention may collect respondent users case acceptance/decline percentages and may make this information public. In one embodiment, publicly sharing this information may reduce the dismissal rate by cautioning complainant users before serving respondent users.

If the respondent declines/ignores the invitation, the case is dismissed. If the respondent accepts the invitation, at a step 825, the respondent is accepted into the case. At a step 830, The case acceptance rate is updated, the case commences and the method 800 ends.

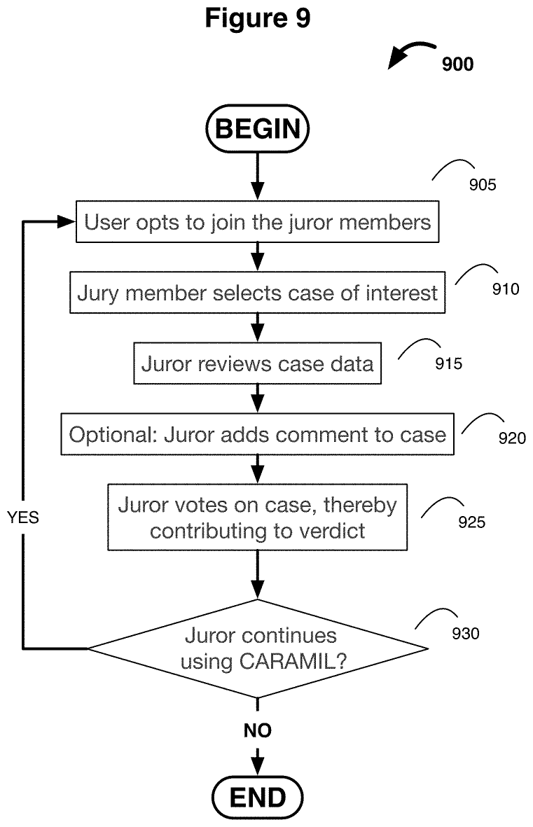

FIG. 9 illustrates a method for case selection for jury users, according to one embodiment of the current disclosure. Although the method steps are described in conjunction with FIGS. 1-18, persons skilled in the art will understand that any system configured to perform the method steps, in any order, falls within the scope of the present invention. The steps in this method are illustrative only and do not necessarily need to be performed in the given order they are presented herein. Some steps may be omitted completely.

The method 900 begins at a step 905 in which a user may opt to join a case as a juror member. At a step 910, a jury member may select a case of interest. At a step 915, juror reviews case data. At an optional step 920, the juror may add a comment to the case. At a step 925, the juror may vote on case, thereby contributing to verdict. At a step 930, the juror may decide whether or not to continue using CARAMIL. If the juror does not wish to continue using CARAMIL, the method 900 ends. If juror does wish to continue using CARAMIL, the method returns to a step 905. Optionally, jurors may change their vote if the case the juror recently voted in is still in deliberation. This may occur, by way of example and not limitation if, a juror user voted, then read a new comment that was added to the case that changes their perspective, they can change their vote from one party to the other.

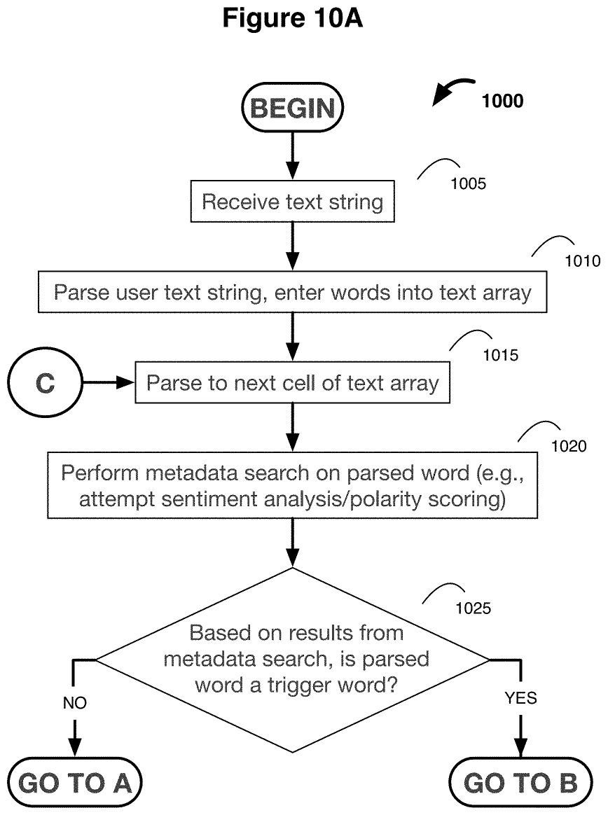

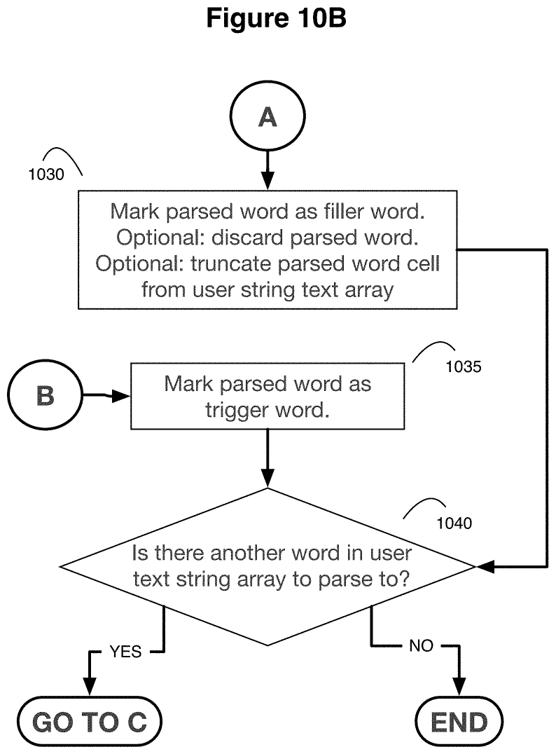

FIGS. 10A and 10B illustrate a method for filtration of user text input strings for trigger words, according to one embodiment of the current disclosure. Although the method steps are described in conjunction with FIGS. 1-18, persons skilled in the art will understand that any system configured to perform the method steps, in any order, falls within the scope of the present invention. The steps in this method are illustrative only and do not necessarily need to be performed in the given order they are presented herein. Some steps may be omitted completely.

The method 1000 begins at a step 1005 in which a user text string may be received. By way of example and not limitation the user text string may be a case issue entered by a complainant or text entered by a respondent or a suggestion made by a jury member to resolve the dispute between the complainant or respondent.

At a step 1010, the words of the user text string may be entered into a cell in a user string text array, such as arrays described herein. At a step 1015, the next word may be parsed. At a step 1020, a metadata search may be performed on the parsed word in order to determine if parsed word is a trigger word or a filler word. In one embodiment, this metadata search may take the form of sentiment analysis. In this embodiment the sentiment analyzer (which may, in one embodiment, execute sentiment analysis methods described herein) may return a sentiment score or an “unknown” sentiment. An unknown sentiment refers the possibility that the parsed word has no known sentiment. In another embodiment, the metadata search may take the form of polarity scoring. In this embodiment, the polarity scorer (e.g. which may, in one embodiment, execute polarity scoring methods described herein) may return a positive, negative neutral or “no” polarity score. A score of “no” polarity refers to the possibility that no known polarity has been assigned to the parsed words. If the methods discussed herein return either or a polarity score or known sentiment or both, then, in one embodiment, the parsed word may be considered as a trigger word, and one or more of these scores may be saved in arrays and databases mentioned herein. The inventor contemplates all combinations of known/unknown polarity scores, sentiment scores, and any other metadata described herein to be used in a determination as to whether or not a word is a trigger word, filler word and/or any other words described herein.

At a step 1025, a determination may be made whether the parsed word is considered a trigger word. In one embodiment, if the parsed word returns one or more of an “unknown sentiment” or “no polarity,” then the parsed word is not considered a trigger word, and the method 1000 continues to a step 1030, in which the parsed word may be marked as filler. Optionally, the parsed word may be removed from the user string text array and the user string text array may be truncated to remove the empty cell, after which the method 1000 continues to step 1040.

If the parsed word is considered a trigger word based on the metadata search results, then, at a step 1035, the parsed word may be marked as a trigger word. At a step 1040, a determination may be made as whether any word remaining in the user text string array to parse to. If there are words remaining, the method 1000 returns to step 1015. If there are no words remaining, the method 1000 ends.

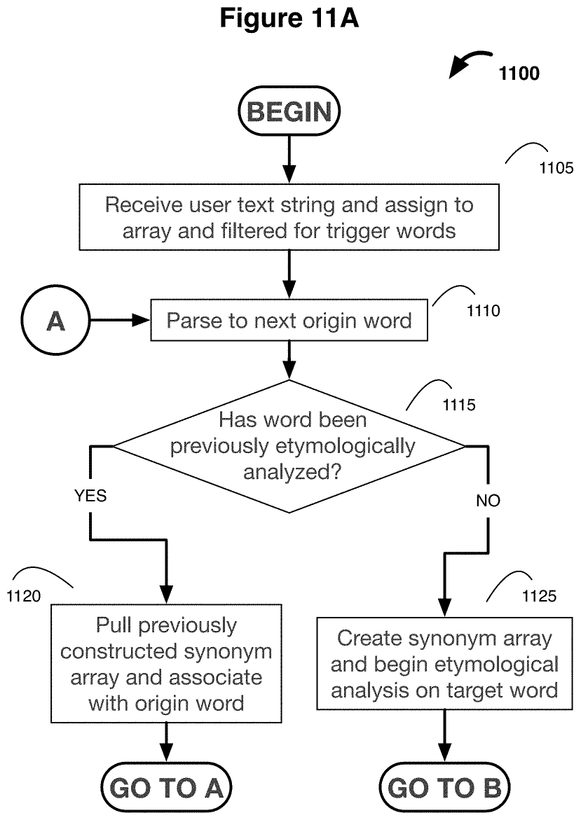

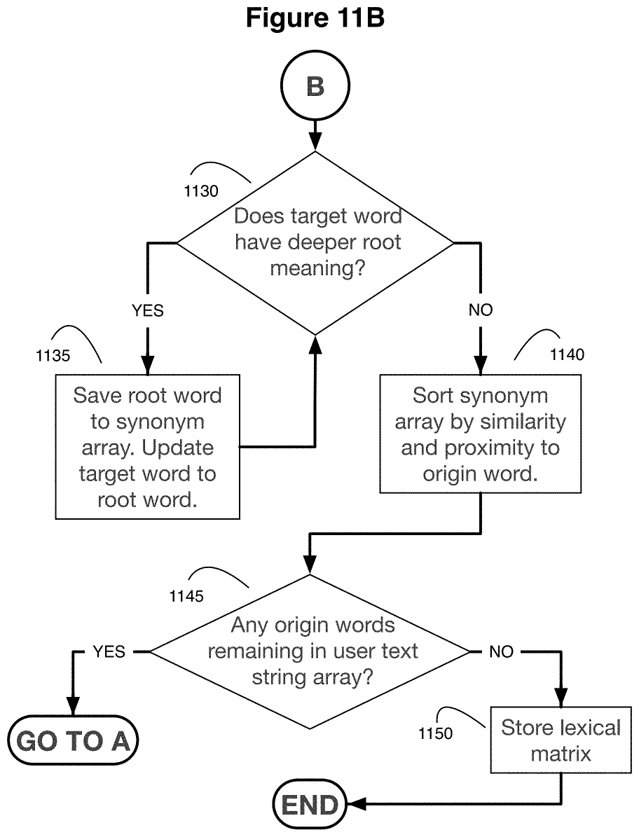

FIGS. 11A and 11B illustrate a method for lexical matrix construction, according to one embodiment of the current disclosure. Although the method steps are described in conjunction with FIGS. 1-18, persons skilled in the art will understand that any system configured to perform the method steps, in any order, falls within the scope of the present invention. The steps in this method are illustrative only and do not necessarily need to be performed in the given order they are presented herein. Some steps may be omitted completely.

The method 1100 begins at a step 1105 wherein a user text string may be received, and may be passed into a user text string array. By way of example and not limitation, the user text string may be a comment written by a CARAMIL user, however any text string may be processed by method 1100. In another embodiment, the user text string may not have been assigned to a comment array or lexical matrix before. In one embodiment, the user text string array may have cells, wherein each cell may contain one word from the the user text string, wherein each word may be referred to as an “origin word,” (i.e., original to the user text string.) More detail on lexical matrix construction is provided herein.

Continuing in this step 1105, a user text string may be broken down and filtered for “trigger words.” In one embodiment, trigger words may be origin words with emotional connotation, versus, in a further embodiment, “filler words.” Such filtering is described in FIG. 10 and elsewhere herein. At a step 1110, the next origin word in the user string text array may be parsed to.

At a step 1115, a determination may be made as to whether the origin word has previously been etymologically analyzed by CARAMIL to the origin word's root meaning.

In one embodiment, etymological analysis on words such as an origin word may have occurred in the past, and CARAMIL may have stored these results in arrays in databases described herein. In one embodiment, etymological analysis may result in synonym arrays that may be stored in case history data 510. In this embodiment, synonym arrays stored in case history data 510 may be arranged in such a way that some data (e.g., synonym arrays) may be pulled from case history data without pulling other data (e.g., complainant or respondent private data).

If the origin word has previously been etymologically analyzed by CARAMIL, the method 1100 goes to a step 1120. If the origin word has not been etymologically analyzed by CARAMIL, the method 1100 goes to a step 1125.

At a step 1120, the synonym array associated with the origin word may be pulled from databases described herein and the synonym array may be linked with origin word cell and user text string array, after which the method 1100 returns to step 1110.

In one embodiment, the user text string array and synonym array may share a common nexus: the origin word cell, also referred to as a nexus cell, and the origin word may also be referred to as a nexus word. In this embodiment, the user text string array and the synonym array may be thought of as orthogonal to one another. In this manner, a new lexical matrix is formed as the construction of two arrays with at least one common cell (the origin word).

In another embodiment, the origin word may have a ‘primary’ position in the synonym array, and cells in the synonym array that neighbor the primary position may be used to contain synonyms and the neighboring distance of the synonyms may reflect the similarity of the synonyms and the origin word. In a further embodiment, metadata related to the synonyms may reflect the similarity of the synonym and the origin word instead of or in combination with proximity (neighboring distance).

At a step 1125, the word under analysis may be saved as a “target word” for to have iterative etymological analysis performed on it. Note, in one embodiment, the word under analysis may be the target word. In this step 1125, a synonym array may be created to allow for synonym placement and iterative etymological analysis to break target word down into a deeper root meaning begins.

Ata step 1130, a determination may be made through etymological analysis as to whether the target word has a deeper root meaning. In one embodiment, a “deeper root meaning” refers to a parent or categorial relationship with the target word. By way of example and not limitation, if the target word is “dog,” a root word may be “pet” or “mammal.” This search for deeper root meaning may continue until a final root is found. By way of example and not limitation, a root meaning of mammal may be “animal,” and so on. In another embodiment, a dictionary data collection may be used to begin iterative etymological analysis. In this embodiment, only words that are previously unknown to either CARAMIL or the dictionary data collection would have iterative etymological analysis performed upon the words, thus saving time and energy.

If the target word does have a deeper root meaning, at a step 1135, the root word may be saved into the synonym array. The target word is updated with the root word and the method 1100 returns to step 1130.

If the target word does not have a deeper root meaning, at a step 1140, the synonym array may be sorted by proximity to the origin word, after which the method proceeds to step 1145. in one embodiment, sorting may be done by algorithms described herein (e.g., using a k-NN algorithm) or other known means.

At a step 1145, a determination may be made as to whether there is another origin word in the user text string array to parse to. If there is another origin word, the method returns to step 1110. If there are no remaining origin words, at a step 1150, the lexical matrix is stored in databases mentioned herein, after which the method 1100 ends. In one embodiment, the lexical matrix is stored in case history data 510 or lexical matrix storage 535.

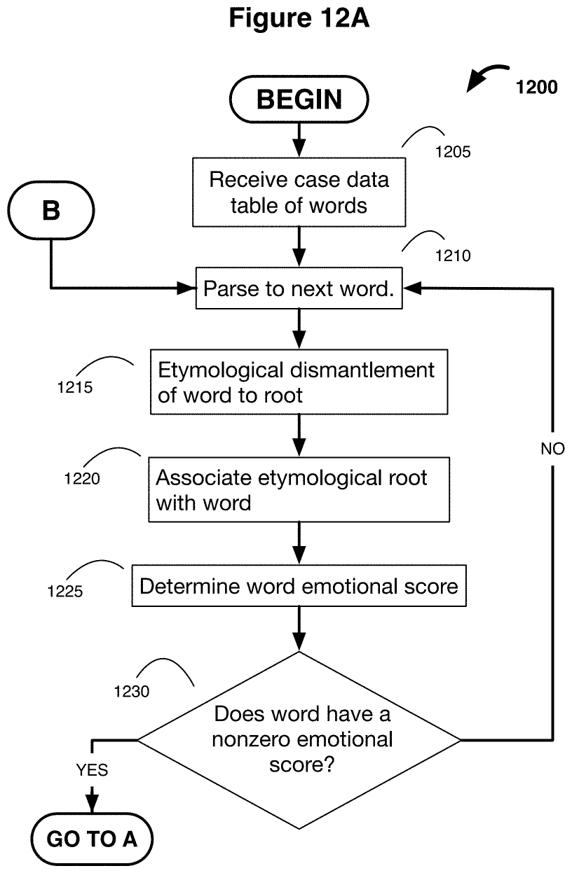

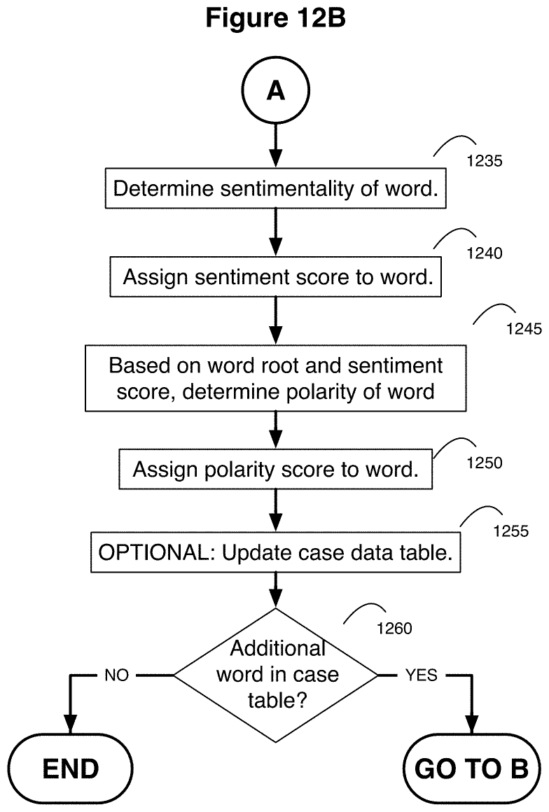

FIGS. 12A and 12B illustrate a method for sentiment and polarity analysis, according to one embodiment of the current disclosure. Although the method steps are described in conjunction with FIGS. 1-18, persons skilled in the art will understand that any system configured to perform the method steps, in any order, falls within the scope of the present invention. The steps in this method are illustrative only and do not necessarily need to be performed in the given order they are presented herein. Some steps may be omitted completely.

The method 1200 begins at a step 1205 In which a case data table of words may be received. At a step 1210, the case data table may be parsed through to the next word. At a step 1215, the word may be dismantled to the word's etymological root. At a step 1220, the etymological root of the word may be associated with the word. At a step 1225, the word's emotional score may be determined. A determination may be made at step 1230 as to whether or not the word's emotional score is nonzero. If the word's emotional score is zero, the method 1200 returns to step 1210. If the word's emotional score is nonzero, the method 1200 proceeds to step 1235.

At a step 1235, the sentimentality of the word may be determined. At a step 1240, a sentiment score may be assigned to the word. in one embodiment, a sentiment score may be from 1 to 5 or unknown, 1 representing “calm” and 5 representing” angry. At a step 1245, the polarity of the word may be determined at least on, by way of example and not limitation, the word's etymological root and sentimentality score. in one embodiment, polarity may be positive, neutral, negative or unknown. At a step 1250, a polarity score may be assigned. At an optional step 1255, the case data table may be updated. At a step 1260, a determination is made as to whether additional words remain in the case table. If additional words remain, the method 1200 returns to step 1210. If no additional words remain, the method 1200 ends.

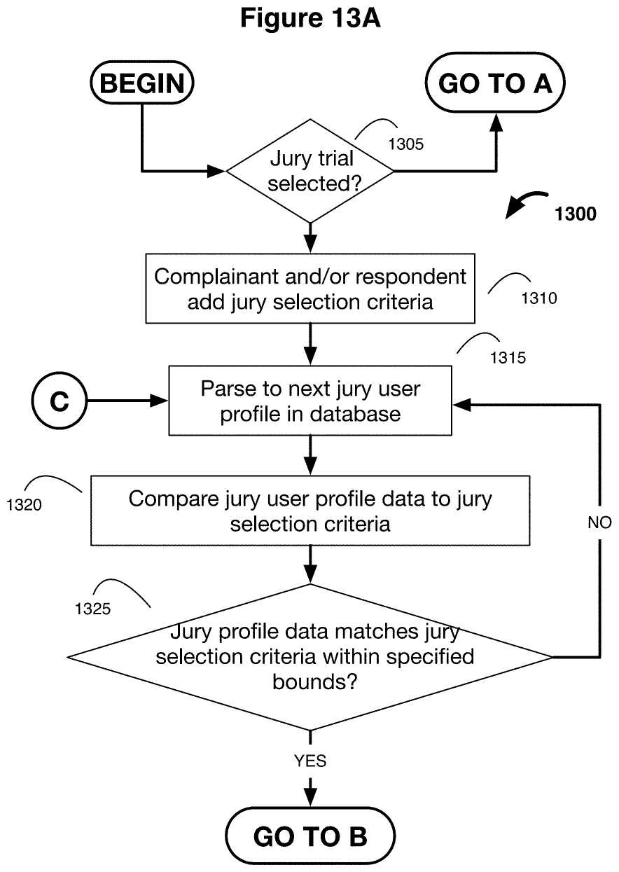

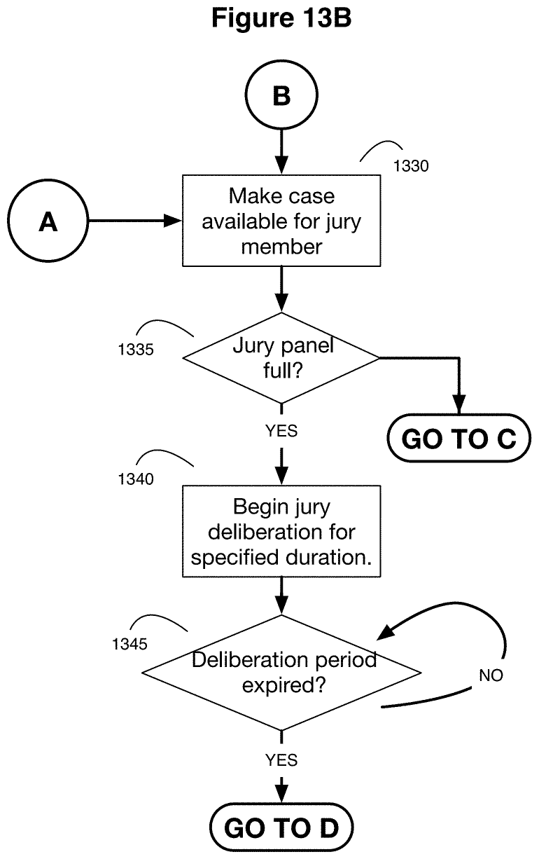

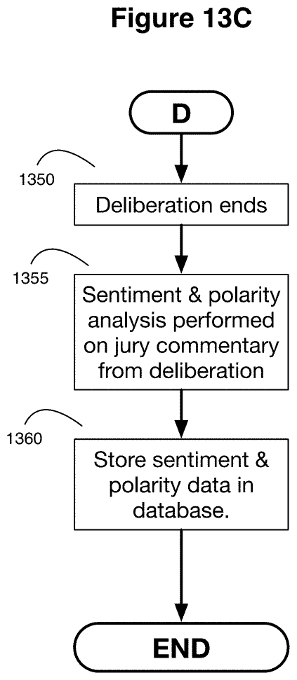

FIGS. 13A, 13B and 13C illustrate a method for conducting voir dire and deliberation, according to one embodiment of the current disclosure. Although the method steps are described in conjunction with FIGS. 1-18, persons skilled in the art will understand that any system configured to perform the method steps, in any order, falls within the scope of the present invention. The steps in this method are illustrative only and do not necessarily need to be performed in the given order they are presented herein. Some steps may be omitted completely.

The method 1300 begins at a step 1305 in which a determination is made as to whether a jury trial has been selected. In one embodiment, the complainant may opt for a jury trial. In another embodiment, the respondent may opt for a jury trial. In another embodiment, the complainant and respondent may opt for a jury trial. All combinations of option selection are contemplated by the inventor. If a jury trial is not selected, the method 1300 proceeds to step 1330. If a jury trial is selected, the method 1300 proceeds to step 1310.

At a step 1310, the complainant and/or respondent may add jury selection criteria. At a step 1315, the jury user profile database may be parsed through to the next jury user. At a step 1320, a jury user profile may be compared to the jury selection criteria. At a step 1325, a determination is made as to whether the jury profile data matches jury selection criteria within specified bounds. In one embodiment, specified bounds may be a 100% match between jury selection criteria as selected by both complainant and respondent. If Jury profile data does not match jury selection criteria within specified bounds, the method 1300 returns to a step 1315. If Jury profile data does match jury selection criteria within specified bounds, the method 1300 proceeds to step 1330. At a step 1330, the case may be made available for the jury member.

At an optional step 1335, a determination is made as to whether the jury panel is full. In one embodiment: the jury panel may be full after a specified number of jurors is reached. In another embodiment, the jury panel may be full after a specified number of jurors matching one or more of complainant and respondent jury criteria is reached. In another embodiment, the jury panel may not have a limit, and step 1335 is skipped, and the method 1300 progresses to step 1340.

At a step 1340, the jury may deliberate for a specified period of time. At a step 1345, a determination is made as to whether the deliberation period has expired. Until the deliberation period has expired, the method pauses. Once the deliberation period has expired, the method 1300 proceeds to a step 1350, in which deliberation ends. At a step 1355, sentiment analysis and/or polarity scoring may be applied to jury commentary made during deliberation. It is important to note that this step may occur simultaneously with step 1350. In other words, sentiment analysis and/or polarity scoring may be applied to jury commentary as jury commentary is entered during the deliberation period. At step 1360, sentiment and polarity data may be stored and the method 1300 ends.

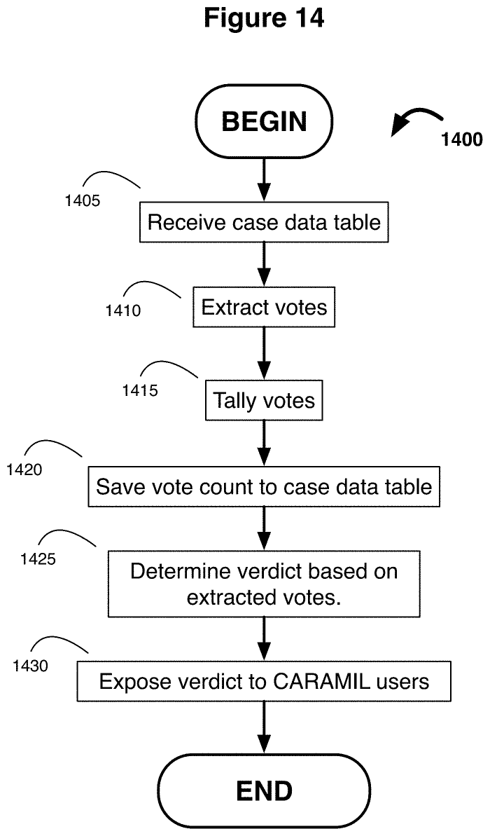

FIG. 14 illustrates a method for generating verdicts, according to one embodiment of the current disclosure. Although the method steps are described in conjunction with FIGS. 1-18, persons skilled in the art will understand that any system configured to perform the method steps, in any order, falls within the scope of the present invention. The steps in this method are illustrative only and do not necessarily need to be performed in the given order they are presented herein. Some steps may be omitted completely.

The method 1400 begins at a step 1405 in which the case data table is retrieved. At a step 1410, votes may be extracted. At a step 1415, votes may be tallied. At a step 1420, the vote count is saved to the case data table. At a step 1425, the verdict is determined based on the extracted votes. In one embodiment, the verdicts may be based on a majority vote. All voting methods and verdict determination methods are contemplated by the inventor. At a step 1430, the verdict is exposed to users and the method 1400 ends.

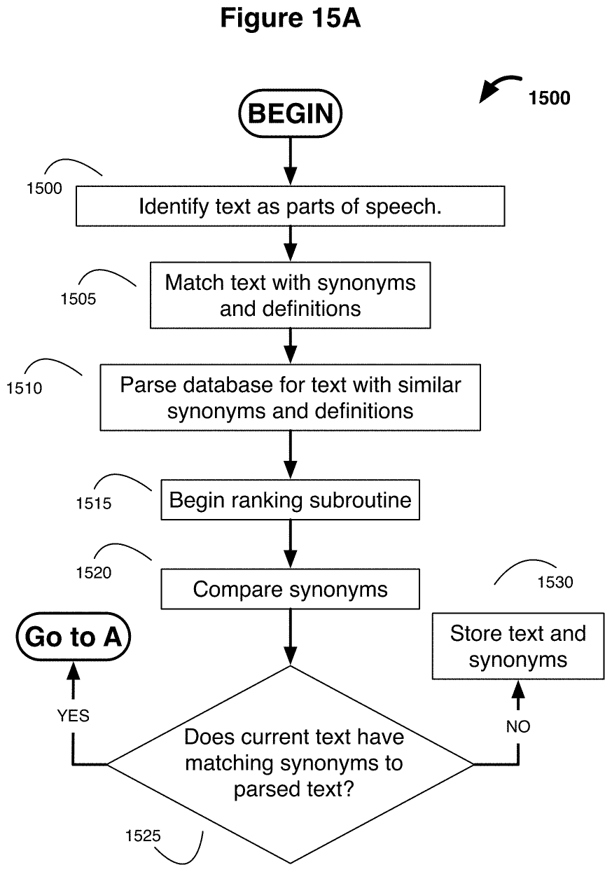

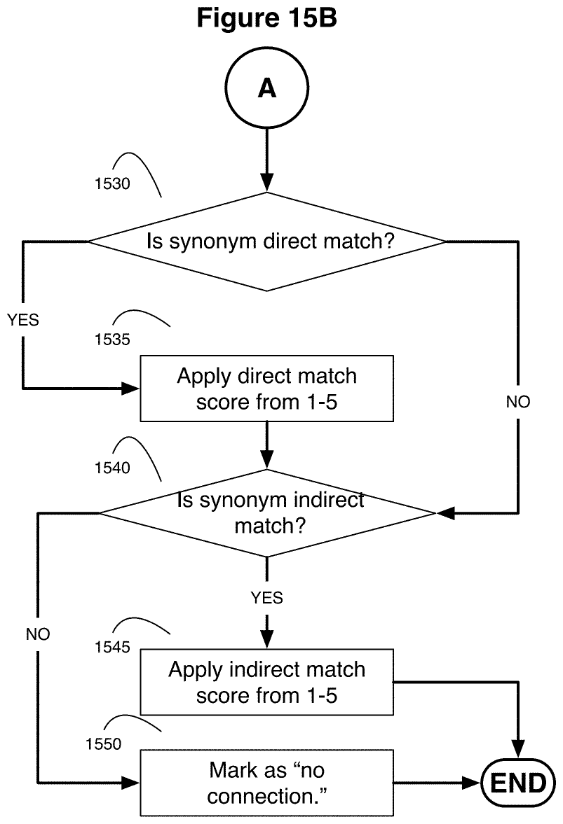

FIGS. 15A and 15B illustrates a method for a synonym array generation performed by a machine intelligence, according to one embodiment of the current disclosure. Although the method steps are described in conjunction with FIGS. 1-18, persons skilled in the art will understand that any system configured to perform the method steps, in any order, falls within the scope of the present invention. The steps in this method are illustrative only and do not necessarily need to be performed in the given order they are presented herein. Some steps may be omitted completely.

The method 1500 begins at a step 1505 in which text may be identified and sorted as parts of speech (e.g. nouns, verbs, adjectives, etc.). At a step 1510, text may be matched with a list of synonyms and definitions of said case keywords. At a step 1515, text may be parsed for similar synonyms and definitions. At a step 1520, a ranking subroutine (e.g., k-NN algorithm) may be employed. At a step 1525, synonyms may be compared to each noun, verb and adjective in the text under analysis.

At a step 1530, a determination may be made as whether the current text has matching synonyms with other text. If there are no matching synonyms, the text and the synonyms may be stored and may be tested against future text in future iterations of method 1500. It is important to note that synonym generation in this step, even if the there are no matching synonyms, allows for faster text comparison in the future since text's synonyms may be pre-generated in this manner.

If the text does have one or more matching synonyms, at a step 1535, a further determination is made as to whether the synonym match is a first, second or third degree match. A first degree match is determined based on the degree of proximity between the word currently being analyzed and that word's synonyms. By way of example and not limitation, the word “roommate” may have a first degree match with a synonym of “housemate,” but only a second or third degree match with a synonym of “friend.” In one embodiment, match degree may depend on similarity between synonyms or other criteria or metadata described herein.

If there is a first degree match (in one embodiment, this is a direct match), at a step 1540, a direct match score may be applied, after which the method 1500 ends. In one embodiment, a direct match score may be applied from a scale of 1-5, in which the direct match score may be chosen based on methods known in the art. Optionally, this result may be stored for later use (e.g. in hypotheses database 530).

If there is a second or third degree match (in one embodiment, this is a indirect match), at a step 1545, an indirect match score may be applied. In one embodiment, an indirect match score may be applied from a scale of 1-5, in which the indirect match score may be chosen based on methods known in the art. Optionally, this result may be stored in databases described herein. The method 1500 then ends.

In one embodiment, the nearest degree (closest) indirect match is still ranked lower than the lowest degree (farthest) direct match. In another embodiment, degree match may be based on synonym proximity, to the word under analysis. In this manner, either a direct or indirect match may be determined by a first, second or any degree match, and the inventor contemplates any and all combinations.

By way of example and not limitation, a case issue comparison is provided. This example uses a case currently under analysis by a machine intelligence as compared to previous cases, all under the category of “alcoholism” follows. In this example, a complainant user submits a case with an issue of “roommate has a drinking problem” against a respondent user. Embodiments disclosed herein may parse through text from the complainant and respondent users, applying all known synonyms to each keyword from the text. In this example, special focus is given to the issue text of “roommate has a drinking problem.” Embodiments disclosed herein may compare case issue words such as “roommate” with other synonyms (e.g. “housemate” or “friend”) and “drinking” with “consume alcohol,” etc. Using methods such as method 1500 and/or other methods described herein, CARAMIL may determine that there may be two other cases in case history with issues that return as direct matches. Further in this example, embodiments disclosed herein may determine that one case is a higher match than the other case since there may be more direct matches (after examination using method 1500 and other methods described herein) with the case issue currently under analysis (“roommate has a drinking problem.”) In this manner, CARAMIL may find similar cases based on case issues, and use this information for, among other things, predicting jury verdicts and/or case outcomes.

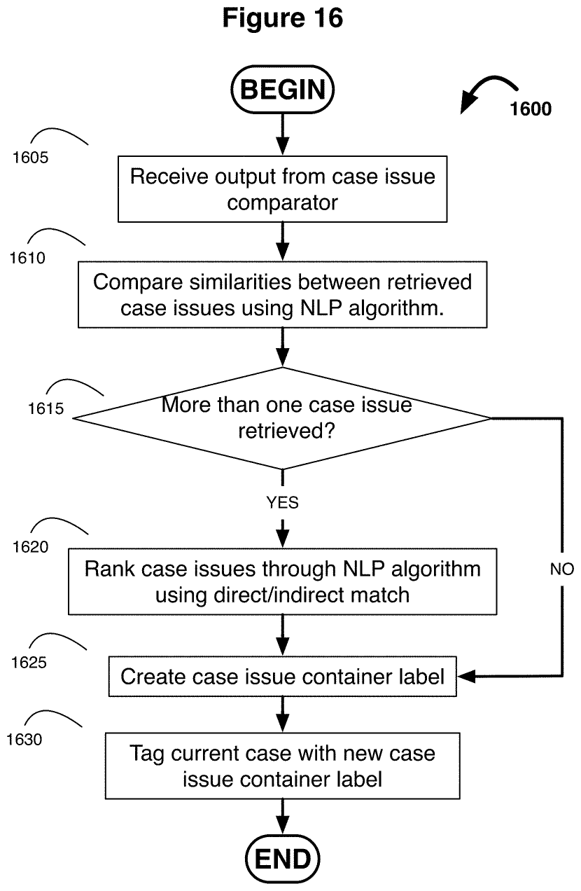

FIG. 16 illustrates method for case issue comparison and case issue sorting by a machine intelligence, according to one embodiment of the current disclosure. Although the method steps are described in conjunction with FIGS. 1-18, persons skilled in the art will understand that any system configured to perform the method steps, in any order, falls within the scope of the present invention. The steps in this method are illustrative only and do not necessarily need to be performed in the given order they are presented herein. Some steps may be omitted completely.

The method 1600 begins at step 1605 in which output from case issue handler is received. In one embodiment, this output may be in the form of an unsorted or partially sorted list of case issues from databases mentioned herein. At a step 1610, a natural language processing algorithm that utilizes a sentiment recognition system may be employed. In one embodiment, the natural language processing method from FIG. 15 is employed.

At a step 1615, a direct or indirect percentage-match between two or more case issues is output. At a step 1620, a determination may be made as to whether more than one case issue has been retrieved. If only one case has been retrieved, the method 1600 continues to a step 1630. If more than one case has been retrieved, the method 1600 continues to a step 1625, in which the retrieved cases may be ranked. In one embodiment, a ranking method (e.g., from FIG. 15) may be employed. Further still in this embodiment, case issue comparator may rank two or more case issues similar to the issue of the case currently under analysis.

At a step 1630, a case issue container label may be created. In one embodiment, this case issue container label may be generated based on the results of common synonyms derived from retrieved case issues. In a further embodiment, this case issue container label may be based on case issues pulled from NLP algorithms described herein.

At a step 1635, the case currently under analysis may be tagged using the case issue container label, and the method 1600 ends.

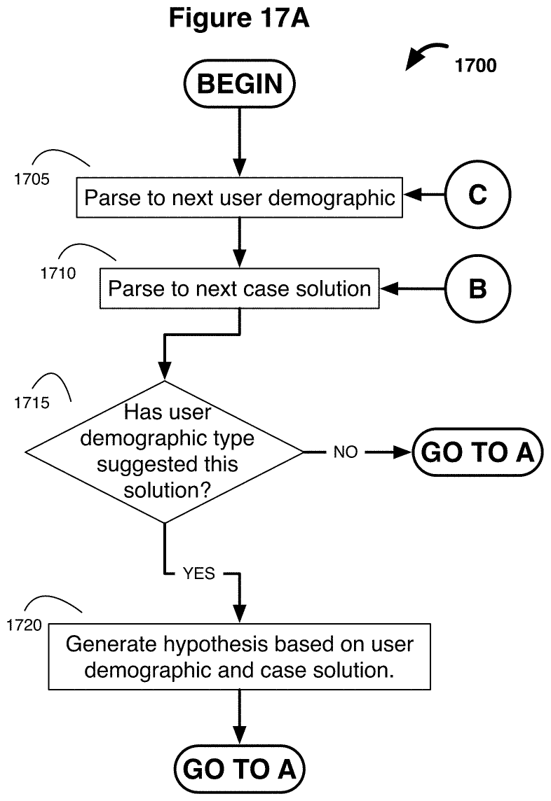

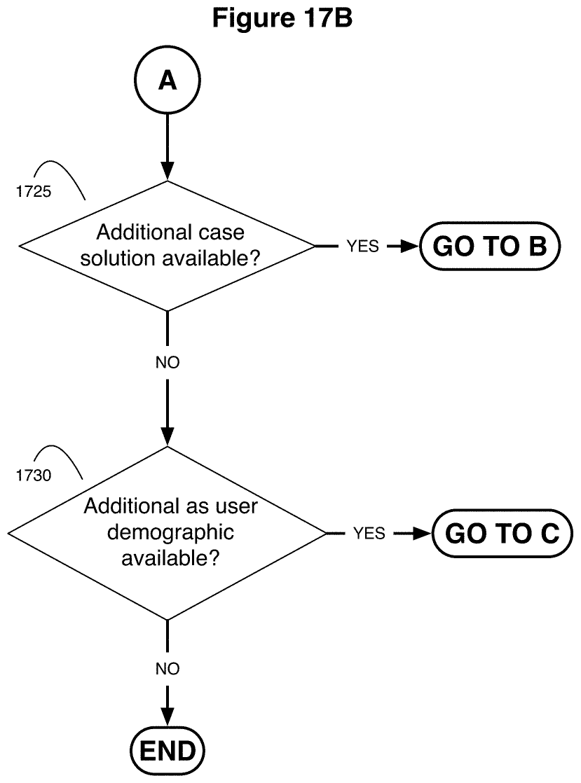

FIGS. 17A and 17B illustrate a method for hypothesizing and pattern recognition between user demographics and previous case solutions by a machine intelligence, according to one embodiment of the current disclosure. Although the method steps are described in conjunction with FIGS. 1-18, persons skilled in the art will understand that any system configured to perform the method steps, in any order, falls within the scope of the present invention. The steps in this method are illustrative only and do not necessarily need to be performed in the given order they are presented herein. Some steps may be omitted completely.

The method 1700 begins at a step 1705 in which a user demographic type is parsed. At a step 1710, a solution to a previous case is parsed. In a step 1715, the user demographic type is compared to the solution and a determination is made as to whether the user demographic type has suggested an equivalent to this solution in the past. (Note: solution equivalents may be determined by NLP or other algorithms). If that user demographic type has not suggested an equivalent to that solution, the method 1700 proceeds to step 1725.

If that user demographic type has suggested an equivalent to that solution, then at a step 1720 hypothesis is generated that may effectively state that the current user demographic type will vote in alignment with the current solution. In one embodiment, a hypothesis may be generated by lexical matrix creation through a hypothesizer (by way of example and not limitation, hypothesizer 627) through methods described herein.

Then, the method proceeds to a step 1725. At a step 1725, a determination is made as to whether an additional case solution is available to be parsed. If another case solution is available, the method 1700 returns to a step 1705. If there are no more user demographics available to be parsed, the method 1700 proceeds to a step 1730.

At a step 1730, a determination is made as to whether an additional user demographic is available to be parsed. If another user demographic is available, the method 1700 returns to a step 1710. If there are no more user demographics available to be parsed, the method 1700 ends.

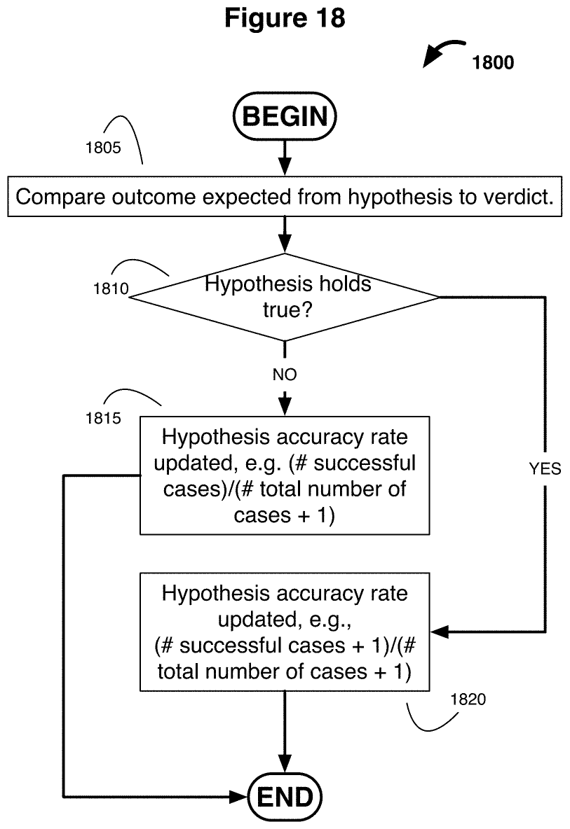

FIG. 18 illustrates a method for a hypothesis occurrence iteration and refinement that may executed by a machine intelligence, according to one embodiment of the current disclosure. Although the method steps are described in conjunction with FIGS. 1-18, persons skilled in the art will understand that any system configured to perform the method steps, in any order, falls within the scope of the present invention. The steps in this method are illustrative only and do not necessarily need to be performed in the given order they are presented herein. Some steps may be omitted completely.

The method 1800 begins with a step 1805 in which the case outcome (e.g. verdict) is compared to the outcome expected from the hypothesis. By way of example and not limitation, a hypothesis may be that if jury member (age=21 & currently enrolled in college), then jury member will have lower sentiment towards alcohol. Thus, in this example, the outcome expected of the hypothesis is that this jury member will vote in favor of defending the alleged alcoholic.

At a step 1810, a determination is made as to whether the case outcome matches the outcome expected of the hypothesis. If the outcome expected from the hypothesis does not match the verdict, the method 1800 continues to a step 1815 in which the hypothesis occurrence rate is updated. In one embodiment, the hypothesis occurrence rate may be decreased in the following manner; the number of accurate outcomes of the hypothesis (numerator) may remain the same and the total number of cases (denominator) is increased, and the method 1800 ends. If however, the outcome expected by the hypothesis does match the verdict, the method 1800 moves to a step 1820, and the hypothesis occurrence rate is increased to reflect this change, after which the method 1800 ends.

In this manner, hypotheses occurrence rates may rise or fall based on the number of times the hypotheses held true as compared to the total number of cases in which the hypotheses were applicable, thus allowing for refinement of a machine intelligence.

The above illustration provides many different embodiments or embodiments for implementing different features of the invention. Specific embodiments of components and processes are described to help clarify the invention. These are, of course, merely embodiments and are not intended to limit the invention from that described in the following claims.

What is claimed:

1. A processor-based method for refining a machine intelligence comprising the steps of:
parsing to a first unresolved case in a set of unresolved cases;
parsing to a first resolved case in a set of resolved cases;
performing a case similarity determination as to whether the first resolved case is similar to the first unresolved case;
if the case similarity determination results in similarity;
loading a resolved case solution associated with the first resolved case;
converting the resolved case solution into a hypothesis associated with the first unresolved case; and,
performing a solution similarity determination as to whether the hypothesis is similar to an unresolved case solution;
if the solution similarity determination results in similarity,
increasing a hypothesis accuracy rate; or,
if the solution similarity determination results in dissimilarity,
decreasing the hypothesis accuracy rate.

2. The method of claim 1, further including the steps of:
if the case similarity determination results in dissimilarity; parsing to a second resolved case in the set of resolved cases.

3. The method of claim 1, further including the steps of:
wherein the hypothesis accuracy rate is increased by:
incrementing a total successful cases counter; and,
incrementing a total number of cases counter.

4. The method of claim 1, further including the steps of:
wherein the hypothesis accuracy rate is decreased by:
incrementing a total number of cases counter.

5. The method of claim 1, wherein the case similarity determination is performed by:
a lexical matrix comparison algorithm.

6. The method of claim 1, wherein the solution similarity determination is performed by:
a lexical matrix comparison algorithm.

7. The method of claim 1, wherein conversion of the resolved case solution into a hypothesis further includes the steps of:
copying the resolved case solution;
identifying the copied resolved case solution as the hypothesis; and,
tagging the copied resolved case solution as related to the first unresolved case.

8. A processor-based method for refining a machine intelligence comprising the steps of:
loading a first solution;
loading a second solution;
loading a hypothesis; and,
performing a solution similarity determination as to whether the hypothesis is similar to either the first solution or the second solution;
if the hypothesis is similar to the first solution:
increasing a first hypothesis accuracy rate.

9. The method of claim 8, further including the steps of:
if the hypothesis is similar to the second solution:
increasing a second hypothesis accuracy rate.

10. The method of claim 8,
wherein the first solution is biased towards a complainant.

11. The method of claim 8,
wherein the second solution is biased towards a defendant.

12. The method of claim 8,
wherein the hypothesis is associated with a case.

13. The method of claim 8,
wherein the first hypothesis accuracy rate is associated with the first solution.

14. The method of claim 8,
wherein the second hypothesis accuracy rate is associated with the second solution.

15. The method of claim 8, further including the steps of:
if the hypothesis is dissimilar to both the complainant-biased solution and the defendant-biased solution;
storing the hypothesis.

16. The method of claim 8, wherein the solution similarity determination is performed by:
a lexical matrix comparison algorithm.

17. A processor-based method for refining a machine intelligence comprising the steps of:
performing a solution similarity determination as to whether a hypothesis is similar to an unresolved case solution;
if the solution similarity determination results in similarity,
increasing a hypothesis accuracy rate; or,
if the solution similarity determination results in dissimilarity,
decreasing the hypothesis accuracy rate.
